(19) United States
(12) Patent Application Publication
(10) Pub. No.: US 2025/0293741 A1
(43) Pub. Date: Sep. 18, 2025

(54) METHODS AND APPARATUS FOR REFERENCE SIGNAL OVERHEAD REDUCTION IN WIRELESS COMMUNICATION SYSTEMS

(71) Applicant: InterDigital Patent Holdings, Inc., Wilmington, DE (US)

(72) Inventors: Mohamed Salah Ibrahim, Chesterbrook, PA (US); Arnab Roy, Phoenixville, PA (US); Yugeswar Deenoo Narayanan Thangaraj, Chalfont, PA (US); Moon IL Lee, Melville, NY (US); Arman Shojaeifard, London (GB); Mihaela Beluri, Jericho, NY (US)

(21) Appl. No.: 18/860,454

(22) PCT Filed: Apr. 26, 2023
(86) PCT No.: PCT/US2023/019912

§ 371 Date: Oct. 25, 2024

Related U.S. Application Data
(60) Provisional application No. 63/335,038, filed on Apr. 26, 2022.

(51) Int. Cl. H04B 7/06; H04B 17/373; H04L 5/00

(52) U.S. Cl. CPC H04B 7/0626; H04B 17/373; H04L 5/0048

(57) ABSTRACT

Procedures, methods, architectures, apparatuses, systems, devices, and computer program products directed to reduction of signaling overhead in connection with processing of reference signals. In an embodiment, an apparatus may be configured to receive, from a network node, configuration information comprising channel state information (CSI) spatial prediction parameters; receive a first plurality of reference signals transmitted from a plurality of antenna ports of the network node; estimate, based on the plurality of the received reference signals, first CSI measurements; and determine, based on the first CSI measurements and the CSI spatial prediction parameters, a first subset of antenna ports among the plurality of antenna ports of the network node and one or more parameters associated with the first subset of antenna ports, wherein the first subset is less than the plurality of antenna ports.

### CROSS-REFERENCE TO RELATED APPLICATIONS

This application claims the benefit of U.S. Provisional Patent Application No. 63/335,038 filed Apr. 26, 2022, which is incorporated herein by reference.

### FIELD

The present disclosure is generally directed to the field of wireless communications networks. For example, one or more embodiments disclosed herein are related to methods, apparatuses, systems, and/or procedures for reducing signaling overhead in connection with reference signals, particularly, but not exclusively, in 3GPP cellular network systems.

### BACKGROUND

For downlink scheduling and link adaptation purposes for both single user (SU) and multiple user (MU)-MIMO (multiple input multiple output), accurate knowledge of the channel may be used. This may be achieved using downlink (DL) channel state information (CSI) reference signals (CSI-RS) to enable channel estimation at the UE, and by feeding back the estimated CSI (e.g., implicit CSI: channel quality indicator (CQI), pre-coding matrix indicator (PMI), rank indicator (RI), layer indicator (LI)) in the UE CSI reports. However, as 5G NR supports up to 32 antenna ports, there is a large overhead associated with the DL CSI-RS, and the corresponding uplink (UL) CSI reports. This overhead may be expected to increase as the system bandwidth and the number of antennas may increase in B5G (beyond 5G) massive MIMO systems.

### BRIEF DESCRIPTION OF THE DRAWINGS

A more detailed understanding may be had from the detailed description below, given by way of example in conjunction with the drawings appended hereto. Figures in such drawings, like the detailed description, are exemplary. As such, the Figures and the detailed description are not to be considered limiting, and other equally effective examples are possible and likely. Furthermore, like reference numerals (“ref.”) in the Figures (“FIGS.”) indicate like elements, and wherein:

FIG. 1A is a system diagram illustrating an example communications system in which one or more disclosed embodiments may be implemented;

FIG. 1B is a system diagram illustrating an example wireless transmit/receive unit (WTRU) that may be used within the communications system illustrated in FIG. 1A according to an embodiment;

FIG. 1C is a system diagram illustrating an example radio access network (RAN) and an example core network (CN) that may be used within the communications system illustrated in FIG. 1A according to an embodiment;

FIG. 1D is a system diagram illustrating a further example RAN and a further example CN that may be used within the communications system illustrated in FIG. 1A according to an embodiment;

FIG. 2 is diagram illustrating an example of a configuration for CSI reporting settings, resource settings, and links;

FIG. 3 is a diagram illustrating codebook-based precoding with feedback information;

FIG. 4 is a diagram illustrating a DNN (deep neural network) model for predicting the channel matrix for one subset of channels based on the channel matrix of another subset of channels in accordance with an embodiment;

FIGS. 5 and 6 are graphical representations showing the results of simulations in 3D space and 2D space, respectively, illustrating the correlation of the channels in a selected subset of channels in accordance with an embodiment;

FIGS. 7A and 7B are graphical representations showing the results of simulations of two embodiments and show the RB indices associated with any (e.g., each) cluster and the representative RB for any (e.g., each) cluster and demonstrate the minimum correlation coefficient associated with any (e.g., each) embodiment;

FIG. 8 illustrates an example of a method for reducing signaling overhead in connection with reference signals; and

FIG. 9 illustrates another example of a method for reducing signaling overhead in connection with reference signals.

### DETAILED DESCRIPTION

### Introduction

In the following detailed description, numerous specific details are set forth to provide a thorough understanding of embodiments and/or examples disclosed herein. However, it will be understood that such embodiments and examples may be practiced without some or all of the specific details set forth herein. In other instances, well-known methods, procedures, components, and circuits have not been described in detail, so as not to obscure the following description. Further, embodiments and examples not specifically described herein may be practiced in lieu of, or in combination with, the embodiments and other examples described, disclosed, or otherwise provided explicitly, implicitly and/or inherently (collectively “provided”) herein.

Although various embodiments are described and/or claimed herein in which an apparatus, system, device, etc. and/or any element thereof carries out an operation, process, algorithm, function, etc. and/or any portion thereof, it is to be understood that any embodiments described and/or claimed herein assume that any apparatus, system, device, etc. and/or any element thereof is configured to carry out any operation, process, algorithm, function, etc. and/or any portion thereof.

### Example Communication Systems and Devices

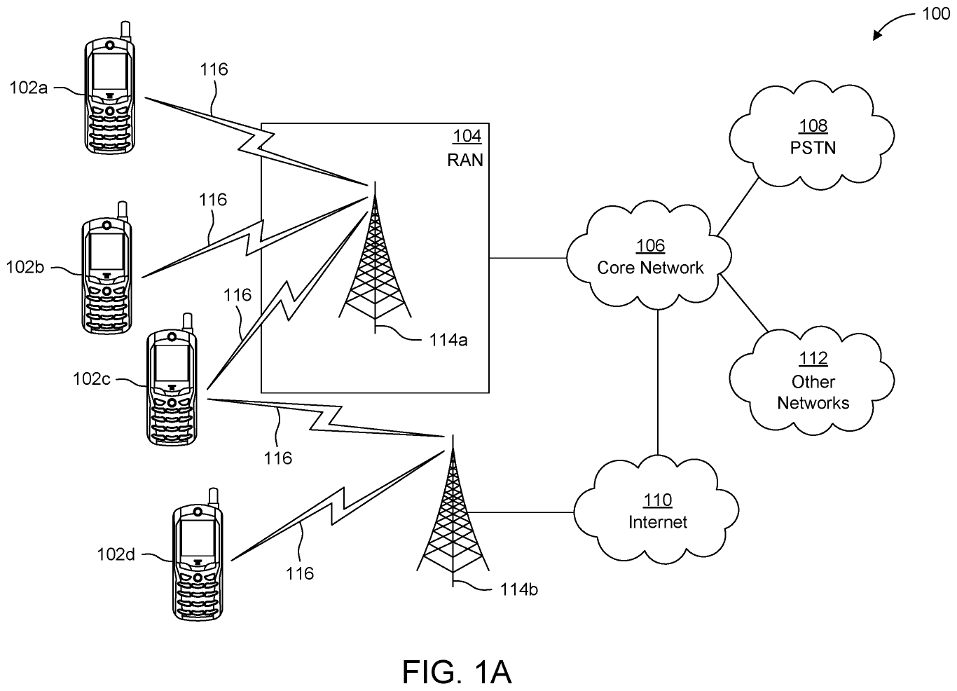

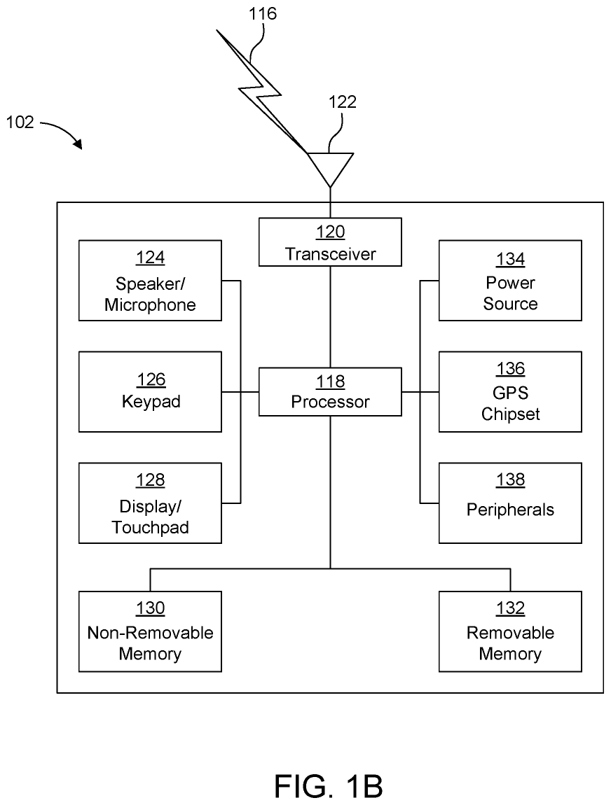

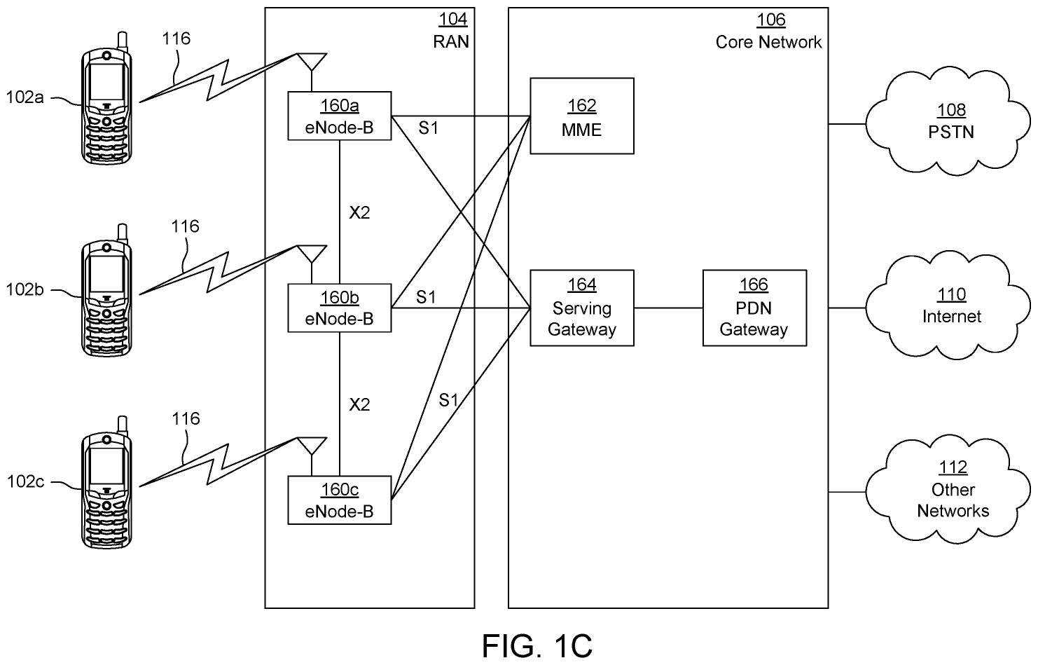

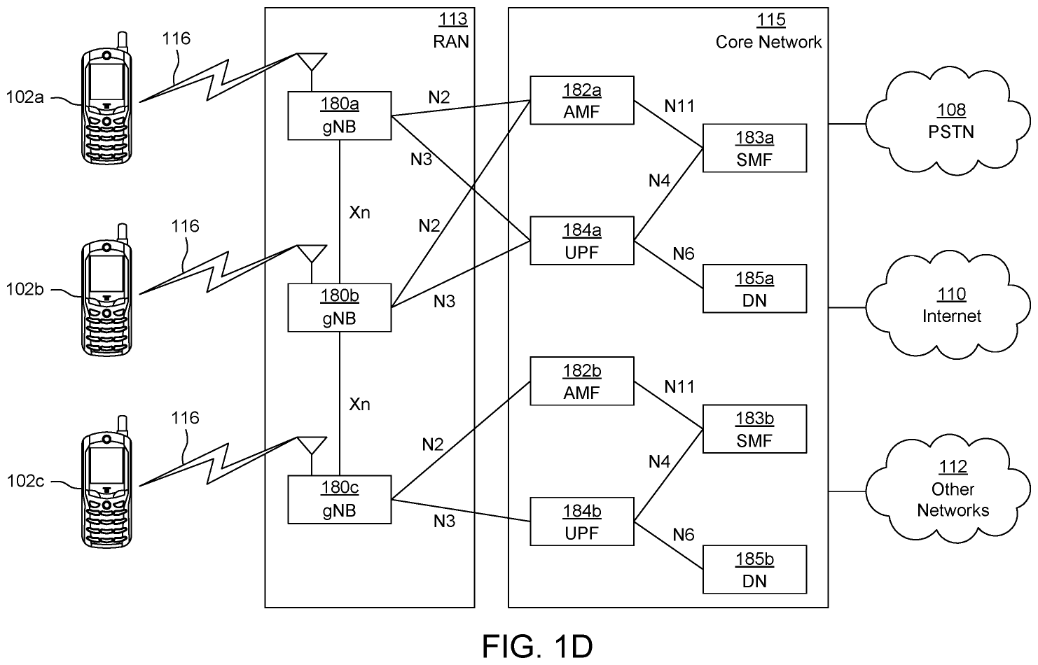

The methods, apparatuses and systems provided herein are well-suited for communications involving both wired and wireless networks. Wired networks are well-known. An overview of various types of wireless devices and infrastructure is provided with respect to FIGS. 1A-1D, where various elements of the network may utilize, perform, be arranged in accordance with and/or be adapted and/or configured for the methods, apparatuses and systems provided herein.

FIG. 1A is a diagram illustrating an example communications system 100 in which one or more disclosed embodiments may be implemented. The communications system 100 may be a multiple access system that provides content, such as voice, data, video, messaging, broadcast, etc., to multiple wireless users. The communications system 100 may enable multiple wireless users to access such content through the sharing of system resources, including wireless bandwidth. For example, the communications systems 100 may employ one or more channel access methods, such as code division multiple access (CDMA), time division multiple access (TDMA), frequency division multiple access (FDMA), orthogonal FDMA (OFDMA), single-carrier FDMA (SC-FDMA), zero-tail unique-word DFT-Spread OFDM (ZT UW DTS-s OFDM), unique word OFDM (UW-OFDM), resource block-filtered OFDM, filter bank multicarrier (FBMC), and the like.

As shown in FIG. 1A, the communications system 100 may include wireless transmit/receive units (WTRUs) 102a, 102b, 102c, 102d, a RAN 104/113, a CN 106/115, a public switched telephone network (PSTN) 108, the Internet 110, and other networks 112, though it will be appreciated that the disclosed embodiments contemplate any number of WTRUs, base stations, networks, and/or network elements. Each of the WTRUs 102a, 102b, 102c, 102d may be any type of device configured to operate and/or communicate in a wireless environment. By way of example, the WTRUs 102a, 102b, 102c, 102d, any of which may be referred to as a “station” and/or a “STA”, may be configured to transmit and/or receive wireless signals and may include a user equipment (UE), a mobile station, a fixed or mobile subscriber unit, a subscription-based unit, a pager, a cellular telephone, a personal digital assistant (PDA), a smartphone, a laptop, a netbook, a personal computer, a wireless sensor, a hotspot or Mi-Fi device, an Internet of Things (IoT) device, a watch or other wearable, a head-mounted display (HMD), a vehicle, a drone, a medical device and applications (e.g., remote surgery), an industrial device and applications (e.g., a robot and/or other wireless devices operating in an industrial and/or an automated processing chain contexts), a consumer electronics device, a device operating on commercial and/or industrial wireless networks, and the like. Any of the WTRUs 102a, 102b, 102c and 102d may be interchangeably referred to as a UE.

The communications systems 100 may also include a base station (BS) 114a and/or a base station 114b. Each of the base stations 114a, 114b may be any type of device configured to wirelessly interface with at least one of the WTRUs 102a, 102b, 102c, 102d to facilitate access to one or more communication networks, such as the CN 106/115, the Internet 110, and/or the other networks 112. By way of example, the base stations 114a, 114b may be a base transceiver station (BTS), a Node-B, an eNode B, a Home Node B, a Home eNode B, a gNB, a NR NodeB, a site controller, an access point (AP), a wireless router, and the like. While the base stations 114a, 114b are each depicted as a single element, it will be appreciated that the base stations 114a, 114b may include any number of interconnected base stations and/or network elements.

The base station 114a may be part of the RAN 104/113, which may also include other base stations and/or network elements (not shown), such as a base station controller (BSC), a radio network controller (RNC), relay nodes, etc. The base station 114a and/or the base station 114b may be configured to transmit and/or receive wireless signals on one or more carrier frequencies, which may be referred to as a cell (not shown). These frequencies may be in licensed spectrum, unlicensed spectrum, or a combination of licensed and unlicensed spectrum. A cell may provide coverage for a wireless service to a specific geographical area that may be relatively fixed or that may change over time. The cell may further be divided into cell sectors. For example, the cell associated with the base station 114a may be divided into three sectors. Thus, in one embodiment, the base station 114a may include three transceivers, i.e., one for each sector of the cell. In an embodiment, the base station 114a may employ MIMO technology and may utilize multiple transceivers for each sector of the cell. For example, beamforming may be used to transmit and/or receive signals in desired spatial directions.

The base stations 114a, 114b may communicate with one or more of the WTRUs 102a, 102b, 102c, 102d over an air interface 116, which may be any suitable wireless communication link (e.g., radio frequency (RF), microwave, centimeter wave, micrometer wave, infrared (IR), ultraviolet (UV), visible light, etc.). The air interface 116 may be established using any suitable radio access technology (RAT).

More specifically, as noted above, the communications system 100 may be a multiple access system and may employ one or more channel access schemes, such as CDMA, TDMA, FDMA, OFDMA, SC-FDMA, and the like. For example, the base station 114a in the RAN 104/113 and the WTRUs 102a, 102b, 102c may implement a radio technology such as Universal Mobile Telecommunications System (UMTS) Terrestrial Radio Access (UTRA), which may establish the air interface 116 using wideband CDMA (WCDMA). WCDMA may include communication protocols such as High-Speed Packet Access (HSPA) and/or Evolved HSPA (HSPA+). HSPA may include High-Speed Downlink Packet Access (HSDPA) and/or High-Speed Uplink Packet Access (HSUPA).

In an embodiment, the base station 114a and the WTRUs 102a, 102b, 102c may implement a radio technology such as Evolved UMTS Terrestrial Radio Access (E-UTRA), which may establish the air interface 116 using Long Term Evolution (LTE) and/or LTE-Advanced (LTE-A) and/or LTE-Advanced Pro (LTE-A Pro).

In an embodiment, the base station 114a and the WTRUs 102a, 102b, 102c may implement a radio technology such as NR Radio Access, which may establish the air interface 116 using New Radio (NR).

In an embodiment, the base station 114a and the WTRUs 102a, 102b, 102c may implement multiple radio access technologies. For example, the base station 114a and the WTRUs 102a, 102b, 102c may implement LTE radio access and NR radio access together, for instance using dual connectivity (DC) principles. Thus, the air interface utilized by WTRUs 102a, 102b, 102c may be characterized by multiple types of radio access technologies and/or transmissions sent to/from multiple types of base stations (e.g., an eNB and a gNB).

In other embodiments, the base station 114a and the WTRUs 102a, 102b, 102c may implement radio technologies such as IEEE 802.11 (i.e., Wireless Fidelity (WiFi), IEEE 802.16 (i.e., Worldwide Interoperability for Microwave Access (WiMAX)), CDMA2000, CDMA2000 1×, CDMA2000 EV-DO, Interim Standard 2000 (IS-2000), Interim Standard 95 (IS-95), Interim Standard 856 (IS-856), Global System for Mobile communications (GSM), Enhanced Data rates for GSM Evolution (EDGE), GSM EDGE (GERAN), and the like.

The base station 114b in FIG. 1A may be a wireless router, Home Node B, Home eNode B, or access point, for example, and may utilize any suitable RAT for facilitating wireless connectivity in a localized area, such as a place of business, a home, a vehicle, a campus, an industrial facility, an air corridor (e.g., for use by drones), a roadway, and the like. In one embodiment, the base station 114b and the WTRUs 102c, 102d may implement a radio technology such as IEEE 802.11 to establish a wireless local area network (WLAN). In an embodiment, the base station 114b and the WTRUs 102c, 102d may implement a radio technology such as IEEE 802.15 to establish a wireless personal area network (WPAN). In yet another embodiment, the base station 114b and the WTRUs 102c, 102d may utilize a cellular-based RAT (e.g., WCDMA, CDMA2000, GSM, LTE, LTE-A, LTE-A Pro, NR etc.) to establish a picocell or femtocell. As shown in FIG. 1A, the base station 114b may have a direct connection to the Internet 110. Thus, the base station 114b may not be required to access the Internet 110 via the CN 106/115.

The RAN 104/113 may be in communication with the CN 106/115, which may be any type of network configured to provide voice, data, applications, and/or voice over internet protocol (VoIP) services to one or more of the WTRUs 102a, 102b, 102c, 102d. The data may have varying quality of service (QoS) requirements, such as differing throughput requirements, latency requirements, error tolerance requirements, reliability requirements, data throughput requirements, mobility requirements, and the like. The CN 106/115 may provide call control, billing services, mobile location-based services, pre-paid calling, Internet connectivity, video distribution, etc., and/or perform high-level security functions, such as user authentication. Although not shown in FIG. 1A, it will be appreciated that the RAN 104/113 and/or the CN 106/115 may be in direct or indirect communication with other RANs that employ the same RAT as the RAN 104/113 or a different RAT. For example, in addition to being connected to the RAN 104/113, which may be utilizing a NR radio technology, the CN 106/115 may also be in communication with another RAN (not shown) employing a GSM, UMTS, CDMA 2000, WiMAX, E-UTRA, or WiFi radio technology.

The CN 106/115 may also serve as a gateway for the WTRUs 102a, 102b, 102c, 102d to access the PSTN 108, the Internet 110, and/or the other networks 112. The PSTN 108 may include circuit-switched telephone networks that provide plain old telephone service (POTS). The Internet 110 may include a global system of interconnected computer networks and devices that use common communication protocols, such as the transmission control protocol (TCP), user datagram protocol (UDP) and/or the internet protocol (IP) in the TCP/IP internet protocol suite. The networks 112 may include wired and/or wireless communications networks owned and/or operated by other service providers. For example, the networks 112 may include another CN connected to one or more RANs, which may employ the same RAT as the RAN 104/113 or a different RAT.

Some or all of the WTRUs 102a, 102b, 102c, 102d in the communications system 100 may include multi-mode capabilities (e.g., the WTRUs 102a, 102b, 102c, 102d may include multiple transceivers for communicating with different wireless networks over different wireless links). For example, the WTRU 102c shown in FIG. 1A may be configured to communicate with the base station 114a, which may employ a cellular-based radio technology, and with the base station 114b, which may employ an IEEE 802 radio technology.

FIG. 1B is a system diagram illustrating an example WTRU 102. As shown in FIG. 1, the WTRU 102 may include a processor 118, a transceiver 120, a transmit/receive element 122, a speaker/microphone 124, a keypad 126, a display/touchpad 128, non-removable memory 130, removable memory 132, a power source 134, a global positioning system (GPS) chipset 136, and/or other peripherals 138, among others. It will be appreciated that the WTRU 102 may include any sub-combination of the foregoing elements while remaining consistent with an embodiment.

The processor 118 may be a general purpose processor, a special purpose processor, a conventional processor, a digital signal processor (DSP), a plurality of microprocessors, one or more microprocessors in association with a DSP core, a controller, a microcontroller, Application Specific Integrated Circuits (ASICs), Field Programmable Gate Arrays (FPGAs) circuits, any other type of integrated circuit (IC), a state machine, and the like. The processor 118 may perform signal coding, data processing, power control, input/output processing, and/or any other functionality that enables the WTRU 102 to operate in a wireless environment. The processor 118 may be coupled to the transceiver 120, which may be coupled to the transmit/receive element 122. While FIG. 1B depicts the processor 118 and the transceiver 120 as separate components, it will be appreciated that the processor 118 and the transceiver 120 may be integrated together in an electronic package or chip.

The transmit/receive element 122 may be configured to transmit signals to, or receive signals from, a base station (e.g., the base station 114a) over the air interface 116. For example, in one embodiment, the transmit/receive element 122 may be an antenna configured to transmit and/or receive RF signals. In an embodiment, the transmit/receive element 122 may be an emitter/detector configured to transmit and/or receive IR, UV, or visible light signals, for example. In yet another embodiment, the transmit/receive element 122 may be configured to transmit and/or receive both RF and light signals. It will be appreciated that the transmit/receive element 122 may be configured to transmit and/or receive any combination of wireless signals.

Although the transmit/receive element 122 is depicted in FIG. 1B as a single element, the WTRU 102 may include any number of transmit/receive elements 122. More specifically, the WTRU 102 may employ MIMO technology. Thus, in one embodiment, the WTRU 102 may include two or more transmit/receive elements 122 (e.g., multiple antennas) for transmitting and receiving wireless signals over the air interface 116.

The transceiver 120 may be configured to modulate the signals that are to be transmitted by the transmit/receive element 122 and to demodulate the signals that are received by the transmit/receive element 122. As noted above, the WTRU 102 may have multi-mode capabilities. Thus, the transceiver 120 may include multiple transceivers for enabling the WTRU 102 to communicate via multiple RATs, such as NR and IEEE 802.11, for example.

The processor 118 of the WTRU 102 may be coupled to, and may receive user input data from, the speaker/microphone 124, the keypad 126, and/or the display/touchpad 128 (e.g., a liquid crystal display (LCD) display unit or organic light-emitting diode (OLED) display unit). The processor 118 may also output user data to the speaker/microphone 124, the keypad 126, and/or the display/touchpad 128. In addition, the processor 118 may access information from, and store data in, any type of suitable memory, such as the non-removable memory 130 and/or the removable memory 132. The non-removable memory 130 may include random-access memory (RAM), read-only memory (ROM), a hard disk, or any other type of memory storage device. The removable memory 132 may include a subscriber identity module (SIM) card, a memory stick, a secure digital (SD) memory card, and the like. In other embodiments, the processor 118 may access information from, and store data in, memory that is not physically located on the WTRU 102, such as on a server or a home computer (not shown).

The processor 118 may receive power from the power source 134, and may be configured to distribute and/or control the power to the other components in the WTRU 102. The power source 134 may be any suitable device for powering the WTRU 102. For example, the power source 134 may include one or more dry cell batteries (e.g., nickel-cadmium (NiCd), nickel-zinc (NiZn), nickel metal hydride (NiMH), lithium-ion (Li-ion), etc.), solar cells, fuel cells, and the like.

The processor 118 may also be coupled to the GPS chipset 136, which may be configured to provide location information (e.g., longitude and latitude) regarding the current location of the WTRU 102. In addition to, or in lieu of, the information from the GPS chipset 136, the WTRU 102 may receive location information over the air interface 116 from a base station (e.g., base stations 114a, 114b) and/or determine its location based on the timing of the signals being received from two or more nearby base stations. It will be appreciated that the WTRU 102 may acquire location information by way of any suitable location-determination method while remaining consistent with an embodiment.

The processor 118 may further be coupled to other peripherals 138, which may include one or more software and/or hardware modules that provide additional features, functionality and/or wired or wireless connectivity. For example, the peripherals 138 may include an accelerometer, an e-compass, a satellite transceiver, a digital camera (for photographs and/or video), a universal serial bus (USB) port, a vibration device, a television transceiver, a hands free headset, a Bluetooth® module, a frequency modulated (FM) radio unit, a digital music player, a media player, a video game player module, an Internet browser, a Virtual Reality and/or Augmented Reality (VR/AR) device, an activity tracker, and the like. The peripherals 138 may include one or more sensors, the sensors may be one or more of a gyroscope, an accelerometer, a hall effect sensor, a magnetometer, an orientation sensor, a proximity sensor, a temperature sensor, a time sensor; a geolocation sensor; an altimeter, a light sensor, a touch sensor, a magnetometer, a barometer, a gesture sensor, a biometric sensor, and/or a humidity sensor.

The WTRU 102 may include a full duplex radio for which transmission and reception of some or all of the signals (e.g., associated with particular subframes for both the uplink (e.g., for transmission) and downlink (e.g., for reception) may be concurrent and/or simultaneous. The full duplex radio may include an interference management unit 139 to reduce and or substantially eliminate self-interference via either hardware (e.g., a choke) or signal processing via a processor (e.g., a separate processor (not shown) or via processor 118). In an embodiment, the WTRU 102 may include a half-duplex radio for which transmission and reception of some or all of the signals (e.g., associated with particular subframes for either the uplink (e.g., for transmission) or the downlink (e.g., for reception)).

FIG. 1C is a system diagram illustrating the RAN 104 and the CN 106 according to an embodiment. As noted above, the RAN 104 may employ an E-UTRA radio technology to communicate with the WTRUs 102a, 102b, 102c over the air interface 116. The RAN 104 may also be in communication with the CN 106.

The RAN 104 may include eNode-Bs 160a, 160b, 160c, though it will be appreciated that the RAN 104 may include any number of eNode-Bs while remaining consistent with an embodiment. The eNode-Bs 160a, 160b, 160c may each include one or more transceivers for communicating with the WTRUs 102a, 102b, 102c over the air interface 116. In one embodiment, the eNode-Bs 160a, 160b, 160c may implement MIMO technology. Thus, the eNode-B 160a, for example, may use multiple antennas to transmit wireless signals to, and/or receive wireless signals from, the WTRU 102a.

Each of the eNode-Bs 160a, 160b, 160c may be associated with a particular cell (not shown) and may be configured to handle radio resource management decisions, handover decisions, scheduling of users in the uplink (UL) and/or downlink (DL), and the like. As shown in FIG. 1C, the eNode-Bs 160a, 160b, 160c may communicate with one another over an X2 interface.

The CN 106 shown in FIG. 1C may include a mobility management entity (MME) 162, a serving gateway (SGW) 164, and a packet data network (PDN) gateway (or PGW) 166. While each of the foregoing elements are depicted as part of the CN 106, it will be appreciated that any of these elements may be owned and/or operated by an entity other than the CN operator.

The MME 162 may be connected to each of the eNode-Bs 162a, 162b, 162c in the RAN 104 via an S1 interface and may serve as a control node. For example, the MME 162 may be responsible for authenticating users of the WTRUs 102a, 102b, 102c, bearer activation/deactivation, selecting a particular serving gateway during an initial attach of the WTRUs 102a, 102b, 102c, and the like. The MME 162 may provide a control plane function for switching between the RAN 104 and other RANs (not shown) that employ other radio technologies, such as GSM and/or WCDMA.

The SGW 164 may be connected to each of the eNode Bs 160a, 160b, 160c in the RAN 104 via the S1 interface. The SGW 164 may generally route and forward user data packets to/from the WTRUs 102a, 102b, 102c. The SGW 164 may perform other functions, such as anchoring user planes during inter-eNode B handovers, triggering paging when DL data is available for the WTRUs 102a, 102b, 102c, managing and storing contexts of the WTRUs 102a, 102b, 102c, and the like.

The SGW 164 may be connected to the PGW 166, which may provide the WTRUs 102a, 102b, 102c with access to packet-switched networks, such as the Internet 110, to facilitate communications between the WTRUs 102a, 102b, 102c and IP-enabled devices.

The CN 106 may facilitate communications with other networks. For example, the CN 106 may provide the WTRUs 102a, 102b, 102c with access to circuit-switched networks, such as the PSTN 108, to facilitate communications between the WTRUs 102a, 102b, 102c and traditional land-line communications devices. For example, the CN 106 may include, or may communicate with, an IP gateway (e.g., an IP multimedia subsystem (IMS) server) that serves as an interface between the CN 106 and the PSTN 108. In addition, the CN 106 may provide the WTRUs 102a, 102b, 102c with access to the other networks 112, which may include other wired and/or wireless networks that are owned and/or operated by other service providers.

Although the WTRU is described in FIGS. 1A-1D as a wireless terminal, it is contemplated that in certain representative embodiments that such a terminal may use (e.g., temporarily, or permanently) wired communication interfaces with the communication network.

In representative embodiments, the other network 112 may be a WLAN.

A WLAN in Infrastructure Basic Service Set (BSS) mode may have an Access Point (AP) for the BSS and one or more stations (STAs) associated with the AP. The AP may have an access or an interface to a Distribution System (DS) or another type of wired/wireless network that carries traffic in to and/or out of the BSS. Traffic to STAs that originates from outside the BSS may arrive through the AP and may be delivered to the STAs. Traffic originating from STAs to destinations outside the BSS may be sent to the AP to be delivered to respective destinations. Traffic between STAs within the BSS may be sent through the AP, for example, where the source STA may send traffic to the AP and the AP may deliver the traffic to the destination STA. The traffic between STAs within a BSS may be considered and/or referred to as peer-to-peer traffic. The peer-to-peer traffic may be sent between (e.g., directly between) the source and destination STAs with a direct link setup (DLS). In certain representative embodiments, the DLS may use an 802.11e DLS or an 802.11z tunneled DLS (TDLS). A WLAN using an Independent BSS (IBSS) mode may not have an AP, and the STAs (e.g., all of the STAs) within or using the IBSS may communicate directly with each other. The IBSS mode of communication may sometimes be referred to herein as an “ad-hoc” mode of communication.

When using the 802.1 lac infrastructure mode of operation or a similar mode of operations, the AP may transmit a beacon on a fixed channel, such as a primary channel. The primary channel may be a fixed width (e.g., 20 MHz wide bandwidth) or a dynamically set width via signaling. The primary channel may be the operating channel of the BSS and may be used by the STAs to establish a connection with the AP. In certain representative embodiments, Carrier Sense Multiple Access with Collision Avoidance (CSMA/CA) may be implemented, for example in in 802.11 systems. For CSMA/CA, the STAs (e.g., every STA), including the AP, may sense the primary channel. If the primary channel is sensed/detected and/or determined to be busy by a particular STA, the particular STA may back off. One STA (e.g., only one station) may transmit at any given time in a given BSS.

High Throughput (HT) STAs may use a 40 MHz wide channel for communication, for example, via a combination of the primary 20 MHz channel with an adjacent or nonadjacent 20 MHz channel to form a 40 MHz wide channel.

Very High Throughput (VHT) STAs may support 20 MHz, 40 MHz, 80 MHz, and/or 160 MHz wide channels. The 40 MHz, and/or 80 MHz, channels may be formed by combining contiguous 20 MHz channels. A 160 MHz channel may be formed by combining 8 contiguous 20 MHz channels, or by combining two non-contiguous 80 MHz channels, which may be referred to as an 80+80 configuration. For the 80+80 configuration, the data, after channel encoding, may be passed through a segment parser that may divide the data into two streams. Inverse Fast Fourier Transform (IFFT) processing, and time domain processing, may be done on each stream separately. The streams may be mapped on to the two 80 MHz channels, and the data may be transmitted by a transmitting STA. At the receiver of the receiving STA, the above described operation for the 80+80 configuration may be reversed, and the combined data may be sent to the Medium Access Control (MAC).

Sub 1 GHz modes of operation are supported by 802.11af and 802.11 ah. The channel operating bandwidths, and carriers, are reduced in 802.11af and 802.11ah relative to those used in 802.11n, and 802.11ac. 802.11af supports 5 MHz, 10 MHz, and 20 MHz bandwidths in the TV White Space (TVWS) spectrum, and 802.11ah supports 1 MHz, 2 MHz, 4 MHz, 8 MHz, and 16 MHz bandwidths using non-TVWS spectrum. According to a representative embodiment, 802.11 ah may support Meter Type Control/Machine-Type Communications, such as MTC devices in a macro coverage area. MTC devices may have certain capabilities, for example, limited capabilities including support for (e.g., only support for) certain and/or limited bandwidths. The MTC devices may include a battery with a battery life above a threshold (e.g., to maintain a very long battery life).

WLAN systems, which may support multiple channels, and channel bandwidths, such as 802.11n, 802.11ac, 802.11af, and 802.11ah, include a channel which may be designated as the primary channel. The primary channel may have a bandwidth equal to the largest common operating bandwidth supported by all STAs in the BSS. The bandwidth of the primary channel may be set and/or limited by a STA, from among all STAs in operating in a BSS, which supports the smallest bandwidth operating mode. In the example of 802.11ah, the primary channel may be 1 MHz wide for STAs (e.g., MTC type devices) that support (e.g., only support) a 1 MHz mode, even if the AP, and other STAs in the BSS support 2 MHz, 4 MHz, 8 MHz, 16 MHz, and/or other channel bandwidth operating modes. Carrier sensing and/or Network Allocation Vector (NAV) settings may depend on the status of the primary channel. If the primary channel is busy, for example, due to a STA (which supports only a 1 MHz operating mode), transmitting to the AP, the entire available frequency bands may be considered busy even though a majority of the frequency bands remains idle and may be available.

In the United States, the available frequency bands, which may be used by 802.11ah, are from 902 MHz to 928 MHz. In Korea, the available frequency bands are from 917.5 MHz to 923.5 MHz. In Japan, the available frequency bands are from 916.5 MHz to 927.5 MHz. The total bandwidth available for 802.11ah is 6 MHz to 26 MHz depending on the country code.

FIG. 1D is a system diagram illustrating the RAN 113 and the CN 115 according to an embodiment. As noted above, the RAN 113 may employ an NR radio technology to communicate with the WTRUs 102a, 102b, 102c over the air interface 116. The RAN 113 may also be in communication with the CN 115.

The RAN 113 may include gNBs 180a, 180b, 180c, though it will be appreciated that the RAN 113 may include any number of gNBs while remaining consistent with an embodiment. The gNBs 180a, 180b, 180c may each include one or more transceivers for communicating with the WTRUs 102a, 102b, 102c over the air interface 116. In one embodiment, the gNBs 180a, 180b, 180c may implement MIMO technology. For example, gNBs 180a, 180b may utilize beamforming to transmit signals to and/or receive signals from the gNBs 180a, 180b, 180c. Thus, the gNB 180a, for example, may use multiple antennas to transmit wireless signals to, and/or receive wireless signals from, the WTRU 102a. In an embodiment, the gNBs 180a, 180b, 180c may implement carrier aggregation technology. For example, the gNB 180a may transmit multiple component carriers to the WTRU 102a (not shown). A subset of these component carriers may be on unlicensed spectrum while the remaining component carriers may be on licensed spectrum. In an embodiment, the gNBs 180a, 180b, 180c may implement Coordinated Multi-Point (CoMP) technology. For example, WTRU 102a may receive coordinated transmissions from gNB 180a and gNB 180b (and/or gNB 180c).

The WTRUs 102a, 102b, 102c may communicate with gNBs 180a, 180b, 180c using transmissions associated with a scalable numerology. For example, the OFDM symbol spacing and/or OFDM subcarrier spacing may vary for different transmissions, different cells, and/or different portions of the wireless transmission spectrum. The WTRUs 102a, 102b, 102c may communicate with gNBs 180a, 180b, 180c using subframe or transmission time intervals (TTIs) of various or scalable lengths (e.g., containing varying number of OFDM symbols and/or lasting varying lengths of absolute time).

The gNBs 180a, 180b, 180c may be configured to communicate with the WTRUs 102a, 102b, 102c in a standalone configuration and/or a non-standalone configuration. In the standalone configuration, WTRUs 102a, 102b, 102c may communicate with gNBs 180a, 180b, 180c without also accessing other RANs (e.g., such as eNode-Bs 160a, 160b, 160c). In the standalone configuration, WTRUs 102a, 102b, 102c may utilize one or more of gNBs 180a, 180b, 180c as a mobility anchor point. In the standalone configuration, WTRUs 102a, 102b, 102c may communicate with gNBs 180a, 180b, 180c using signals in an unlicensed band. In a non-standalone configuration WTRUs 102a, 102b, 102c may communicate with/connect to gNBs 180a, 180b, 180c while also communicating with/connecting to another RAN such as eNode-Bs 160a, 160b, 160c. For example, WTRUs 102a, 102b, 102c may implement DC principles to communicate with one or more gNBs 180a, 180b, 180c and one or more eNode-Bs 160a, 160b, 160c substantially simultaneously. In the non-standalone configuration, eNode-Bs 160a, 160b, 160c may serve as a mobility anchor for WTRUs 102a, 102b, 102c and gNBs 180a, 180b, 180c may provide additional coverage and/or throughput for servicing WTRUs 102a, 102b, 102c.

Each of the gNBs 180a, 180b, 180c may be associated with a particular cell (not shown) and may be configured to handle radio resource management decisions, handover decisions, scheduling of users in the uplink (UL) and/or downlink (DL), support of network slicing, dual connectivity, interworking between NR and E-UTRA, routing of user plane data towards User Plane Function (UPF) 184a, 184b, routing of control plane information towards Access and Mobility Management Function (AMF) 182a, 182b and the like. As shown in FIG. 1D, the gNBs 180a, 180b, 180c may communicate with one another over an Xn interface.

The CN 115 shown in FIG. 1D may include at least one AMF 182a, 182b, at least one UPF 184a, 184b, at least one Session Management Function (SMF) 183a, 183b, and possibly a Data Network (DN) 185a, 185b. While each of the foregoing elements are depicted as part of the CN 115, it will be appreciated that any of these elements may be owned and/or operated by an entity other than the CN operator.

The AMF 182a, 182b may be connected to one or more of the gNBs 180a, 180b, 180c in the RAN 113 via an N2 interface and may serve as a control node. For example, the AMF 182a, 182b may be responsible for authenticating users of the WTRUs 102a, 102b, 102c, support for network slicing (e.g., handling of different PDU sessions with different requirements), selecting a particular SMF 183a, 183b, management of the registration area, termination of NAS signaling, mobility management, and the like. Network slicing may be used by the AMF 182a, 182b in order to customize CN support for WTRUs 102a, 102b, 102c based on the types of services being utilized WTRUs 102a, 102b, 102c. For example, different network slices may be established for different use cases such as services relying on ultra-reliable low latency (URLLC) access, services relying on enhanced massive mobile broadband (eMBB) access, services for machine type communication (MTC) access, and/or the like. The AMF 182a, 182b may provide a control plane function for switching between the RAN 113 and other RANs (not shown) that employ other radio technologies, such as LTE, LTE-A, LTE-A Pro, and/or non-3GPP access technologies such as WiFi.

The SMF 183a, 183b may be connected to an AMF 182a, 182b in the CN 115 via an N11 interface. The SMF 183a, 183b may also be connected to a UPF 184a, 184b in the CN 115 via an N4 interface. The SMF 183a, 183b may select and control the UPF 184a, 184b and configure the routing of traffic through the UPF 184a, 184b. The SMF 183a, 183b may perform other functions, such as managing and allocating UE IP address, managing PDU sessions, controlling policy enforcement and QoS, providing downlink data notifications, and the like. A PDU session type may be IP-based, non-IP based, Ethernet-based, and the like.

The UPF 184a, 184b may be connected to one or more of the gNBs 180a, 180b, 180c in the RAN 113 via an N3 interface, which may provide the WTRUs 102a, 102b, 102c with access to packet-switched networks, such as the Internet 110, to facilitate communications between the WTRUs 102a, 102b, 102c and IP-enabled devices. The UPF 184, 184b may perform other functions, such as routing and forwarding packets, enforcing user plane policies, supporting multi-homed PDU sessions, handling user plane QoS, buffering downlink packets, providing mobility anchoring, and the like.

The CN 115 may facilitate communications with other networks. For example, the CN 115 may include, or may communicate with, an IP gateway (e.g., an IP multimedia subsystem (IMS) server) that serves as an interface between the CN 115 and the PSTN 108. In addition, the CN 115 may provide the WTRUs 102a, 102b, 102c with access to the other networks 112, which may include other wired and/or wireless networks that are owned and/or operated by other service providers. In one embodiment, the WTRUs 102a, 102b, 102c may be connected to a local Data Network (DN) 185a, 185b through the UPF 184a, 184b via the N3 interface to the UPF 184a, 184b and an N6 interface between the UPF 184a, 184b and the DN 185a, 185b.

In view of FIGS. 1A-1D, and the corresponding description of FIGS. 1A-1D, one or more, or all, of the functions described herein with regard to one or more of: WTRU 102a-d, Base Station 114a-b, eNode-B 160a-c, MME 162, SGW 164, PGW 166, gNB 180a-c, AMF 182a-b, UPF 184a-b, SMF 183a-b, DN 185a-b, and/or any other device(s) described herein, may be performed by one or more emulation devices (not shown). The emulation devices may be one or more devices configured to emulate one or more, or all, of the functions described herein. For example, the emulation devices may be used to test other devices and/or to simulate network and/or WTRU functions.

The emulation devices may be designed to implement one or more tests of other devices in a lab environment and/or in an operator network environment. For example, the one or more emulation devices may perform the one or more, or all, functions while being fully or partially implemented and/or deployed as part of a wired and/or wireless communication network in order to test other devices within the communication network. The one or more emulation devices may perform the one or more, or all, functions while being temporarily implemented/deployed as part of a wired and/or wireless communication network. The emulation device may be directly coupled to another device for purposes of testing and/or may performing testing using over-the-air wireless communications.

The one or more emulation devices may perform the one or more, including all, functions while not being implemented/deployed as part of a wired and/or wireless communication network. For example, the emulation devices may be utilized in a testing scenario in a testing laboratory and/or a non-deployed (e.g., testing) wired and/or wireless communication network in order to implement testing of one or more components. The one or more emulation devices may be test equipment. Direct RF coupling and/or wireless communications via RF circuitry (e.g., which may include one or more antennas) may be used by the emulation devices to transmit and/or receive data.

### Channel State Information Reporting

Channel State Information, which may include any of the following: channel quality index (CQI), rank indicator (RI), precoding matrix index (PMI), an L1 channel measurement (e.g., reference signal received power (RSRP) such as L1-RSRP, or signal-to-interference-plus-noise ratio (SINR)), CSI-RS resource indicator (CRI), synchronization signals (SS) and physical broadcast channel (SS/PBCH) block resource indicator (SSBRI), layer indicator (LI) and/or any other measurement quantity measured by the WTRU (e.g., UE) from the configured reference signals (e.g. CSI-RS or SS/PBCH block or any other reference signal).

### CSI Reporting Framework

A WTRU (e.g., UE) may be configured to report the CSI, for example, through the uplink control channel on the physical uplink control channel (PUCCH), or per the BS's (e.g., gNB's) request on an uplink physical shared channel (UL PUSCH) grant. For example, depending on the configuration, CSI-RS may cover the full bandwidth of a BandWidth Part (BWP) or just a fraction of it. Within the CSI-RS bandwidth, CSI-RS may be configured in any (e.g., each) Physical Resource Block (PRB) or every other PRB. In the time domain, CSI-RS resources can be configured either periodically, semi-persistently, or aperiodically. Semi-persistent CSI-RS is similar to periodic CSI-RS, except that the resource can be (de)-activated by MAC CEs; and the WTRU (e.g., UE) reports related measurements only when the resource is activated. For aperiodic CSI-RS, the WTRU (e.g., UE) is triggered to report measured CSI-RS on PUSCH by request in a DCI (Downlink Control Information). Periodic reports are carried over the PUCCH, while semi-persistent reports can be carried either on PUCCH or PUSCH. The reported CSI may be used by the scheduler when allocating optimal resource blocks, for example, based on channel's time-frequency selectivity, determining precoding matrices, beams, and/or transmission modes, and selecting suitable Modulation and Coding Schemes (MCSs). The reliability, accuracy, and timeliness of WTRU (e.g., UE) CSI reports may be critical to meeting Ultra-Reliable and Low Latency Communications (URLLC) service requirements.

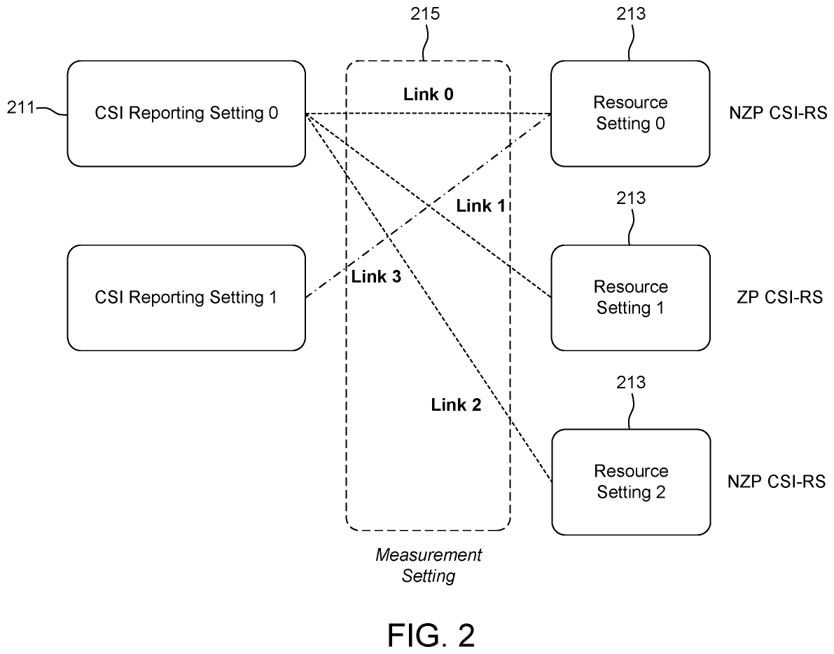

A WTRU (e.g., UE) may be configured with a CSI configuration that may include one or more CSI reporting settings, resource settings, and/or a link between one or more CSI reporting settings and one or more resource settings. The link may be achieved, for instance, by providing pointers to resource configurations within the CSI reporting settings. FIG. 2 shows an example of a configuration for CSI reporting settings, resource settings, and link.

In a CSI configuration, any of the following configuration parameters may be provided:
N≥1 CSI reporting settings 211, M≥1 resource settings 213, and a CSI measurement setting 215 that links the N CSI reporting settings 211 with the M resource settings 213.
A CSI reporting setting 211 may include at least one of the following:
   Time-domain behavior: aperiodic or periodic/semi-persistent.
   Frequency-granularity, at least for PMI and CQI.
   CSI reporting type (e.g., PMI, CQI, RI, CRI, etc.).
   If a PMI is reported, PMI Type (Type I or II) and codebook configuration.
A resource setting 213 may include at least one of the following:
   Time-domain behavior: aperiodic or periodic/semi-persistent.
   RS type (e.g., for channel measurement or interference measurement).
   S≥1 resource set(s) and wherein any (e.g., each) resource set may contain K resources, where K is an integer that may be preconfigured.
A CSI measurement setting 215 may include a linked pair of any of the followings:
   One CSI reporting setting.
   One resource setting.
   For CQI, a reference transmission scheme setting.
For CSI reporting for a component carrier, any of the following frequency granularities may be supported:
   Wideband CSI.
   Partial band CSI.
   Sub band CSI.

### Codebook Based Precoding

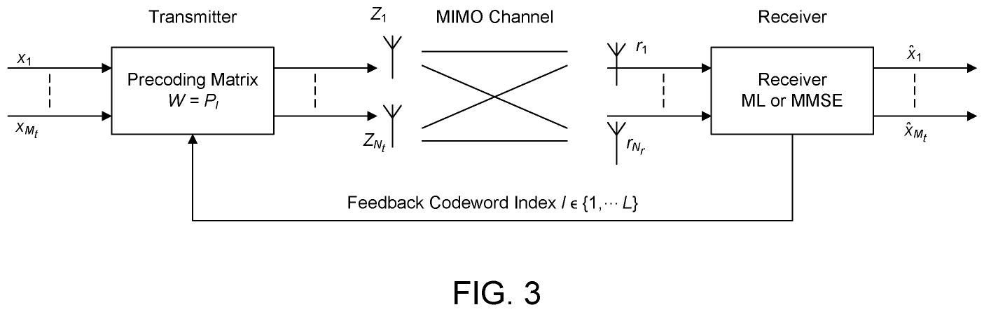

FIG. 3 shows a basic concept of codebook-based precoding with feedback information. The feedback information may include a precoding matrix index (PMI) which may be referred to as a codeword index in the codebook as shown in FIG. 3.

As shown in FIG. 3, a codebook may include a set of precoding vectors/matrices for any (e.g., each) rank and a number of antenna ports, and any (e.g., each) precoding vectors/matrices may have its own index so that a receiver may inform the transmitter of a preferred precoding vector/matrix index. Codebook-based precoding may suffer performance degradation due to its finite number of precoding vectors/matrices as compared with non-codebook-based precoding. However, a major advantage of codebook-based precoding is the possibility of lower control signaling/feedback overhead. Table 1 shows an example of a codebook for 2Tx.

TABLE 1

| Codebook | Number of rank | |
|---|---|---|
| index | 1 | 2 |
| 0 | $\frac{1}{\sqrt{2}} [ \begin{matrix}1 \\ 1\end{matrix} ]$ | $\frac{1}{\sqrt{2}} [ \begin{matrix}1 & 0 \\ 0 & 1\end{matrix} ]$ |
| 1 | $\frac{1}{\sqrt{2}} [ \begin{matrix}1 \\ - 1\end{matrix} ]$ | $\frac{1}{2} [ \begin{matrix}1 & 1 \\ 1 & - 1\end{matrix} ]$ |
| 2 | $\frac{1}{\sqrt{2}} [ \begin{matrix}1 \\ j\end{matrix} ]$ | $\frac{1}{2} [ \begin{matrix}1 & 1 \\ j & - j\end{matrix} ]$ |
| 3 | $\frac{1}{\sqrt{2}} [ \begin{matrix}1 \\ - j\end{matrix} ]$ | — |

### Csi Processing Criteria

A CSI processing unit (CPU) may be referred to as a minimum CSI processing unit and a WTRU (e.g., UE) may support one or more CPUs (e.g., N CPUs). A WTRU (e.g., UE) with N CPUs may estimate N CSI feedback calculations in parallel, wherein N may be a WTRU (e.g., UE) capability. If a WTRU (e.g., UE) is requested to estimate more than N CSI feedbacks at the same time, the WTRU (e.g., UE) may (e.g., only) perform N of the highest priority CSI feedbacks, and the rest may be not estimated.

The starts and ends of a CPU may be determined based on the CSI report type (e.g., aperiodic, periodic, semi-persistent) as any of the followings:
For an aperiodic CSI report, a CPU may start to be occupied from the first OFDM symbol after the physical downlink control channel (PDCCH) trigger until the last OFDM symbol of the PUSCH carrying the CSI report.
For periodic and semi-persistent CSI report, a CPU may start to be occupied from the first OFDM symbol of one or more associated measurement resources (not earlier than CSI reference resource) until the last OFDM symbol of the CSI report.

The number of CPUs occupied may be different based on the CSI measurement types (e.g., beam-based, or non-beam based) as any of the followings:
Non-beam related reports:
   K CPUs when there are K CSI-RS resources in the CSI-RS resource set for channel measurement.
Beam-related reports (e.g., “cri-RSRP” (CSI-RS resource indicator-reference signal received power, “ssb (synchronization signal block)-Index-RSRP”, or “none”):
   One CPU irrespective the number of CSI-RS resource in the CSI-RS resource set for channel measurement due to the CSI computation complexity being low.
   “none” is used for P3 operation or aperiodic Tracking Reference Signal (TRS) transmission.
For an aperiodic CSI reporting with a single CSI-RS resource, one CPU may be occupied.
For a CSI reporting K CSI-RS resources, K CPUs may be occupied as the WTRU (e.g., UE) may (e.g., needs to) perform CSI measurement for any (e.g., each) CSI-RS resource.

When the number of unoccupied CPUs (Na) is less than the required number of CPUs (Nᵣ) for CSI reporting, any of the following WTRU (e.g., UE) behaviors may be used:
The WTRU (e.g., UE) may drop N_r−N_u CSI reporting based on priorities, for example, in the case of uplink control information (UCI) on PUSCH without data/HARQ (hybrid automatic repeat request).
The WTRU (e.g., UE) may report dummy information in Nr−Nu CSI reporting based on priorities, for example, in other cases to avoid rate-matching handling of PUSCH.

### Artificial Intelligence (AI)

Artificial intelligence may be broadly defined as the behavior exhibited by machines. Such behavior may e.g., mimic cognitive functions to sense, reason, adapt and act.

### Machine Learning (ML)

### General Principles of ML

Machine learning may refer to the types of algorithms that solve a problem based on learning through experience (‘data’), without explicitly being programmed (‘configured set of rules’). Machine learning may be considered a subset of AI. Different machine learning paradigms may be envisioned based on the nature of data or feedback available to the learning algorithm. For example, a supervised learning approach may involve learning a function that maps an input to an output based on labeled training example, wherein any (e.g., each) training example may be a pair consisting of input and the corresponding output. For example, an unsupervised learning approach may involve detecting patterns in the data with no pre-existing labels. For example, a reinforcement learning approach may involve performing a sequence of actions in an environment to maximize the cumulative reward. In some embodiments, it is possible to apply machine learning algorithms using a combination or interpolation of the above-mentioned approaches. For example, a semi-supervised learning approach may use a combination of a small amount of labeled data with a large amount of unlabeled data during training. In this regard semi-supervised learning falls between unsupervised learning (with no labeled training data) and supervised learning (with (e.g., only) labeled training data).

### Deep Learning (DL)

Deep learning refers to a class of machine learning algorithms that employ artificial neural networks (e.g., DNNs) which were loosely inspired from biological systems. DNNs are a special class of machine learning models inspired by the human brain wherein the input is linearly transformed and passed-through non-linear activation function multiple times. DNNs typically comprise multiple layers where any (e.g., each) layer comprises a linear transformation and a given non-linear activation functions. DNNs may be trained using the training data via a back-propagation algorithm. Recently, DNNs have shown state-of-the-art performance in a variety of domains, e.g., speech, vision, natural language etc. and for various machine learning settings, such as supervised, un-supervised, and semi-supervised. The term AIML-based methods/processing may refer to realization of behaviors and/or conformance to requirements by learning based on data, without explicit configuration of sequence of steps or actions. Such methods may enable learning complex behaviors that might be difficult to specify and/or implement when using legacy methods.

### Clustering

Clustering is one of the (e.g., most fundamental) tasks in unsupervised machine learning, and has a wide variety of applications in various fields. The clustering task may aim to divide several data samples into a number of separate groups such that the per-group/cluster data samples are more similar/correlated to any (e.g., each) other relative to those in other groups/clusters. Among several clustering approaches, K-means clustering has gained considerable interest due to its simplicity and effectiveness. K-means is an iterative light-weight algorithm that may be generally suitable for clustering data samples that are spread around some centroids. While K-means is an old tool, it has been utilized recently and demonstrates its effectiveness in handling many problems across various domains, including signal processing, data mining, and image processing, to name a few.

### Reducing Reference Signal Overhead

For downlink scheduling and link adaptation purposes for both SU- and MU-MIMO, accurate knowledge of the channel may be used (e.g., is needed). This may be achieved using DL CSI-RS reference signals to enable channel estimation at the WTRU (e.g., UE), and by feeding back the estimated CSI (e.g., implicit CSI: CQI, PMI, RI, LI) in the WTRU (e.g., UE) CSI reports. As 5G NR supports up to 32 antenna ports, there is a large overhead associated with the DL CSI-RS reference signals, and the corresponding UL CSI reports. This overhead may (e.g., is expected to further) increase as the system bandwidth and the number of antennas increase in B5G Massive MIMO systems.

In certain scenarios (e.g., certain antenna configurations and channel conditions), the channel response(s)/CSI corresponding to different Tx antenna ports may be highly correlated. Similarly, high correlation may be observed in the frequency domain, between the channel response(s)/CSI in different sub-bands. When high correlation of the CSI (in either spatial or frequency domain) occurs, it may be leveraged to reduce the density of CSI-RS used (e.g., needed to) accurately estimate the CSI at the WTRU (e.g., UE).

Aspects to be addressed herein include any of the following actions: reducing the RS overhead by transmitting/activating (e.g., only) on a reduced set of antenna ports while attaining close performance to that of the full port transmission, determining which antenna ports to select for the reduced-port CSI-RS transmission and protocols to indicate the reduced set to the BS (e.g., gNB), performing CSI feedback reporting based on the reduced set of antenna ports, reducing the RS overhead by determining a reduced CSI-RS pattern in the frequency domain, determining the reduced CSI-RS pattern in the frequency domain, reporting the selected pattern, and performing CSI feedback reporting based on the reduced pattern in the frequency domain.

### Representative RS Overhead Based on Spatial Correlation

To reduce the CSI-RS overhead, the BS (e.g., gNB) may transmit CSI-RS on a selected subset of antenna ports, for example, as opposed to full port CSI-RS transmission. The WTRU (e.g., UE) (e.g., then) may estimate the reduced channel matrix associated with the selected ports. The estimated reduced channel may be used for different target goals, under different deployment scenarios. For example,
a. AI model at the WTRU (e.g., UE) (e.g., only): a WTRU (e.g., UE) may use the estimated reduced channel response/frequency response/coefficients/matrix (hereafter sometimes referred to simply as “channel” to avoid unnecessary verbiage) of the selected (first) subset to predict the channel associated with the non-selected (second) subset, using an AI model for CSI prediction. The WTRU (e.g., UE) may use the estimated channel based on the first subset, jointly with the predicted channel for the second subset, for example to form the entire channel matrix for further processing at the WTRU (e.g., UE). For example, the WTRU (e.g., UE) may use the entire channel matrix to perform PMI measurements for Type I or Type II CSI feedback.
b. AI model at BS (e.g., gNB) (e.g., only) and joint processing between WTRU (e.g., UE) and BS (e.g., gNB): A WTRU (e.g., UE) may directly send back the estimated reduced channel corresponding to the selected (first) subset. The BS (e.g., gNB) may use the reduced estimated channel associated with the first subset to predict the second subset channel using an AI model for CSI prediction at the BS (e.g., gNB). The BS (e.g., gNB) may form the complete channel matrix and, for example, may use it for precoding purposes (as opposed to legacy methods).

The WTRU (e.g., UE) may also be configured to directly derive/report the precoder index (PMI) associated with the estimated reduced channel of the selected ports (first subset).

### AI Model Description

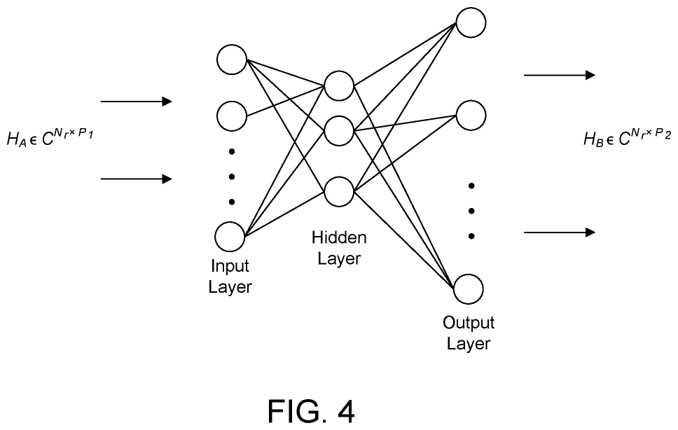

A DNN approach can be adopted to tackle the CSI prediction problem. FIG. 4 shows the layout of a DNN model in accordance with an embodiment. Given the initial (full) estimated channel H_{f}∈ [symbol] ^{N}^{ᵣ}^{×P}, one can construct two reduced channel matrices H_{A}∈ [symbol] ^{N}^{ᵣ}^{×P}^{₁} and H_{B}∈ [symbol] ^{N}^{ᵣ}^{×P}^{₂} where P₁+P₂=P and P₁≤P₂. Let [P₁]={p_{0,1}, p_{1,1}, . . . , p_{P}_{₁}_{-1,1}} denote the subset containing the indices of the selected antenna ports, where p_{j,1} represents the j-th port index associated with the first subset, for j=0, . . . , P₁−1. Similarly, [P₂]{p_{0,2}, p_{1,2}, . . . , p_{P}_{₂}_{-1,2}} may denote the subset containing the indices of the non-selected antenna ports, where p_{i,2} may represent the i-th port index associated with the second subset, for j=0, . . . , P₂−1. By definition, [P₁] and [P₂] may be two disjoint subsets, i.e., P₁∩P₂=ø. A DNN approach can (e.g., then) be designed to predict the channel response/CSI associated with the second subset (H_{B}) given the input of the estimated channel response associated with the first subset (H_{A}).

### Model Training.

For training purposes, N samples may be collected from the full channel matrix H_{f}, i.e., {H_{f}⁽¹⁾, . . . , H_{f}^{(N)}} for n=1, . . . , N. The input-output pairs {(H_{A}⁽¹⁾, H_{B}⁽¹⁾), . . . , (H_{A}^{(N)}, H_{B}^{(N)})} may be constructed based on {H_{f}⁽¹⁾, . . . , H_{f}^{(N)}} to train the DNN.

With reference to FIG. 4, the matrices H_{A} and H_{B} may be constructed in such a way that the column indices (transmit ports indices) follow a particular pattern, e.g., indices are ordered in both subsets, i.e., p_{0,1}<p_{1,1}< . . . <p_{P}_{₁}_{-1,1}, and p_{0,2}<p_{1,2}< . . . <p_{P}_{₂}_{-1,2}. This may reduce the feedback overhead when the DNN model is used at the BS (e.g., gNB). In such a case, the WTRU (e.g., UE) may (e.g., needs to) report (e.g., only) the selected port indices and the associated channel coefficients. Such information may be sufficient to know the column indices of the predicted channel H_{B}. Recall that the DNN model can be placed either at the WTRU (e.g., UE) or the BS (e.g., gNB) or both. The proposed framework can be viewed as means for CSI-RS overhead reduction, channel prediction/mapping from one antenna subset to another, and uplink feedback overhead reduction.

The DNN weights (θ) can be optimized to minimize a particular loss function L. For example, the loss function can be chosen as

$$L = \vert \vert f ( {H}_{A} ; θ ) - {H}_{B} {\vert \vert}_{F}^{2}$$

where f(.) denotes the DNN function.

### Model Feasibility.

In some cases, a mapping may exist between the channel response/CSI of the first subset (H_{A}) and the channel response/CSI of the second subset (H_{B}). Such a relation/mapping may be determined by how spatially-correlated the two antenna subsets [P₁] and [P₂] are. For example, in static communication scenarios, it has been theoretically shown that such a mapping exists.

The performance of the AI/ML model may be contingent on how well-chosen the first (input) subset is. Thus, it may be useful (e.g., is important) to determine the best representative first subset [P₁] that can be used to predict the channel coefficients associated with the second subset [P₂]. In other words, the subset [P₁] should be determined in a way that dictates an inherent relationship between the input and output before training the model.

### Representative Antenna Port Selection

### Representative Determination of a Subset

The WTRU (e.g., UE) may be configured to determine a subset of antenna ports.

The WTRU (e.g., UE) may be configured with a new higher layer parameter, herein termed CSISpatial-PortIndication, which may be contained in a new message, herein termed CSIPred-ReportConfig. The value of this parameter may indicate to the WTRU (e.g., UE) whether or not CSI spatial prediction at the WTRU (e.g., UE) is enabled. If the parameter indicates that CSI spatial prediction is not enabled, the WTRU (e.g., UE) may operate with (e.g., assumes) the BS (e.g., gNB) transmitting CSI-RS using the default time-frequency pattern.

When the higher layer parameter CSISpatial-PortIndication indicates that CSI spatial prediction is enabled, the WTRU (e.g., UE) may operate with (e.g., assumes) the BS (e.g., gNB) not utilizing the default time-frequency pattern for CSI-RS transmission.

In one option, the WTRU (e.g., UE) is provided with antenna ports used by the BS (e.g., gNB) to transmit CSI-RS for channel measurements (P₁). The WTRU (e.g., UE) may operate with (e.g., assumes) CSI-RSs transmitted (e.g., only) on the indicated antenna port indices.

In another option, the WTRU (e.g., UE) may be provided a parameter that corresponds to the maximum number of active antenna ports for CSI-RS transmission by the BS (e.g., gNB) (maxP₁). The WTRU (e.g., UE) may (e.g., then) determine a set of antenna ports, P₁, where P₁≤maxP₁. The WTRU (e.g., UE) may (e.g., then) determine P₁ disjoint sets/groups/clusters of antenna ports, where P₁≤maxP₁. The antenna ports belonging to the p-th set bear spatial relationship with each other and a representative port within the p-th set, at least as far as channel coefficients may be concerned, for p=1, . . . , P₁. The representative port associated with any (e.g., each) set may be defined, for example, as the port with the minimum distance or maximum correlation with all other ports in the same set/group/cluster. It is defined later in the description. The WTRU (e.g., UE) may determine the extent of this spatial relationship between antenna ports within a set based on the maximum number of such sets configured by the network (maxP₁). For example, the WTRU (e.g., UE) may use the cross-correlation value between channel coefficients corresponding to different antenna ports to determine their spatial relationship.

The WTRU (e.g., UE) may respond to the BS (e.g., gNB) with the set of P₁ identified antenna ports, where P₁≤maxP₁. This subset [P₁] is such that, by measuring the channel coefficients on the CSI-RS transmitted on this particular subset of antenna ports, the channel coefficients for all the antenna ports, P, may be determined, e.g., using a suitable DNN.

According to embodiments, the WTRU (e.g., UE) may be configured with a parameter, maxsubseterror, that represents the maximum allowed error between the channel coefficients for the members of a set of antenna ports (cluster/group). The error may be one of either Frobenius norm, mean squared error, etc. The WTRU (e.g., UE) may (e.g., then) determine the minimum number of such sets that can be determined where the per-group members have channel coefficients that differ from each other by an amount less than the configured parameter maxsubseterror. The WTRU (e.g., UE) may (e.g., then) report the number of such sets/clusters/groups, P₁, and/or the indices of the P₁ antenna ports that may be used to perform channel measurements for all the member antenna ports belonging to those sets.

The WTRU (e.g., UE) may report the channel coefficients to the BS (e.g., gNB). According to embodiments, the WTRU (e.g., UE) may use a DNN to estimate the channel coefficients of all the antenna port indices (P), from the measurements made on the sub-set P₁ of the antenna ports. The WTRU (e.g., UE) may then report the channel coefficients for all the antenna port indices.

According to embodiments, the WTRU (e.g., UE) may report the channel coefficients for (e.g., only) the antenna port indices, for example, for which values were directly estimated based on the received CSI-RSs. This may correspond to the port indices used by the BS (e.g., gNB) to transmit the CSI-RSs on. The WTRU (e.g., UE) may (e.g., additionally) report the identities of antenna ports for all members of any (e.g., each) of the P₁ antenna port sets/clusters/groups. The BS (e.g., gNB) may (e.g., then) be able to estimate the channel coefficients for all P antenna ports, for example, by using a DNN to estimate the missing values.

If the WTRU (e.g., UE) determines to report channel coefficients of P₁ antenna ports such that P₁≤maxP₁, where maxP₁ represents the maximum number of antenna ports to be used by the BS (e.g., gNB) for CSI-RS transmission, (e.g., then) the WTRU (e.g., UE) may (e.g., need to) use all the pre-configured uplink resources for reporting the channel coefficients. The WTRU (e.g., UE) may (e.g., then) utilize the resources in a pre-configured manner, for example, the first P₁ resources in time among the maxP₁ allotted resources.

### Representative Preconfiguration of Possible Subsets

The following section describes a port selection based on preconfigured subsets.

The WTRU (e.g., UE) may be pre-configured with multiple sets of antenna port groupings, say with index n₁. Any (e.g., each) set may contain multiple subsets of antenna ports, say with index n₍ₙ_{₁}_{,2)}. Any (e.g., each) antenna port index belonging to a sub-set may bear a certain CSI spatial relationship with other members of the sub-set.

According to embodiments, any (e.g., each) set may be formed, for example, to contain sub-sets with the same number of representative antenna ports (P₁). According to embodiments, any (e.g., each) set may correspond to antenna port groupings that fulfill the condition, for example, that the maximum difference between channel coefficients within a sub-set is less than a pre-configured value, for example, maxsubseterror.

The formation of sets and sub-sets may be such that, for example, one set may contain groupings of antenna ports that any (e.g., each) contain N₁ clusters, another set contains groupings of antenna ports that any (e.g., each) contain N₂ clusters, and yet another set may contain groupings of antenna ports where the maximum difference between the channel coefficients of the group members is smaller than a pre-configured threshold value, for example, maxsubseterror. Within the first set, for example, may be multiple sub-sets (e.g., each) with N₁ clusters, where the individual antenna port memberships may be different. This may be illustrated with an example where, for a total of 64 antenna port indices, a set may contain groupings of 8 antenna port clusters, where (e.g., each) such grouping contains a different combination of the antenna port indices.

The WTRU (e.g., UE) may first choose a set that satisfies the requirements configured by the network, e.g., maximum deviation in channel coefficients between sub-set members is less than maxsubseterror, number of representative antenna ports which correspond to CSI-RS transmissions on the same ports is set to a particular value (P₁)), etc. According to embodiments, the WTRU (e.g., UE) may (e.g., then) choose a sub-set within the chosen set to satisfy any additional criteria. For example, the WTRU (e.g., UE) may choose a sub-set within the set of antenna groupings with maximum difference between channel coefficients less than a configured threshold, for example, maxsubseterror, and (e.g., then) choose a subset among them with the smallest maximum difference between the groupings. According to embodiments, the WTRU (e.g., UE) may choose a sub-set from within a set randomly.

According to embodiments, the WTRU (e.g., UE) may be configured to choose groupings of antenna ports such that the maximum difference between the channel coefficients of group members is smaller than a pre-configured value, for example, maxsubseterror. Within the preconfigured set of such groupings that satisfy the given condition, the WTRU (e.g., UE) may choose a grouping of antenna port indices that minimizes the number of antenna port clusters, e.g., maximizes the size of membership of any (e.g., each) individual antenna port cluster.

The WTRU (e.g., UE) may communicate its choice of the set and sub-set to the BS (e.g., gNB). The WTRU (e.g., UE) may do so, for example, by communicating its choice of the indices n₁ and n₍ₙ_{₁}_{,2)}. According to embodiments, when the WTRU (e.g., UE) is configured with a requirement by the BS (e.g., gNB), for example, the required number of clusters, which sets the first index (n_1), (e.g., then) the WTRU (e.g., UE) may choose a member of the identified sub-set and communicate (e.g., only) the second index, n₍ₙ_{₁}_{,2)}. According to embodiments, when the WTRU (e.g., UE) is configured with a maximum number of clusters by the BS (e.g., gNB) for channel state measurements, (e.g., then) the WTRU (e.g., UE) may determine that multiple sets may satisfy the requirement. The WTRU (e.g., UE) may choose a set among the pre-configured sets that satisfies the condition based on any of: (i) optimizing a secondary criterion, such as smallest number of clusters or maximum inter-member likeness, i.e., smallest maximum difference between the group members or (ii) randomly.

The following section describes WTRU (e.g., UE) methods to dynamically determine the subset of antenna ports.

Determining the best representative subset of antenna ports may be important for several reasons. First, such a subset may yield the minimum feedback overhead while maintaining a target performance, e.g., ϵ—accuracy relative to the full-port setting. Second, a good choice of the candidates of the first subset can (e.g., considerably) improve the performance of the DNN approach which in turn may improve the overall system performance, e.g., block error rate (BLER), throughput, etc. In this section, WTRU (e.g., UE) procedures to determine the entries of the subset [P₁] will be described.

### Mechanism to Determine the Subset of Antenna Ports

The WTRU (e.g., UE) may be configured to determine and report a subset of antenna ports [P₁]={p_{0,1}, p_{1,1}, . . . , p_{P}_{₁}_{-1,1}}, for example, based on the initial estimated full-port channel matrix H_{f}∈ [symbol] ^{N}^{ᵣ}^{×P}.

According to embodiments, the WTRU (e.g., UE) may determine the size of P₁ based on a preconfigured metric, e.g., correlation coefficient, Normalized Mean Square Error (NMSE), etc. Increasing P₁ may (e.g., is expected to) improve the performance of the DNN, while increasing the associated overhead. In contrast, decreasing P₁ may degrade the prediction performance, but may reduce the overhead.

The WTRU (e.g., UE) may apply unsupervised learning methods to the full-port channel matrix H_{f}∈ [symbol] ^{N}^{ᵣ}^{×P} to determine the set of antenna ports [P₁]={p_{0,1}, p_{1,1}, . . . p_{P}_{₁}_{-1,1}}. For example, the WTRU (e.g., UE) may apply clustering methods to cluster the total number of antenna ports to separate groups in such a way that maximizes the intra-group correlation while minimizing the inter-group correlation.

According to embodiments, the WTRU (e.g., UE) may use K-means to cluster the full port channel matrix H_{f}∈ [symbol] ^{N}^{ᵣ}^{×P} to P₁ clusters in the Nᵣ-dimensional space. Note that P₁ may be equivalent to the number of centroids, which is one input to the K-means algorithm. The WTRU (e.g., UE) may determine the number of clusters/centroids/selected ports by iteratively performing measurements for possible preconfigured number of clusters, e.g., P₁ may take one of the predefined values for transmit antenna ports, (2,4,8,12,16,24,32). According to embodiments, the WTRU (e.g., UE) may determine any P₁ value that is below some maximum preconfigured value P₁max. For example, the WTRU (e.g., UE) may start with setting P₁ to P₁max and (e.g., then) compute the minimum per-cluster correlation coefficient ρᵢ, for i=0, . . . , P₁−1, followed by comparing the minimum across ρᵢ, denoted as ρₘᵢₙ, with a preconfigured correlation threshold ρₜₕ. If ρₘᵢₙ(P₁)>ρₜₕ, the WTRU (e.g., UE) may reduce the number of clusters until the minimum number of clusters/ports that meet the correlation test is determined. In contrast, if ρₘᵢₙ(P₁)<ρₜₕ, the WTRU (e.g., UE) may increase the number of clusters.

The WTRU (e.g., UE) may (e.g., then) determine the [P₁]={p_{0,1}, p_{1,1}, . . . , p_{P}_{₁}_{-1,1}} subset by choosing one representative port per cluster. As an example, the port with the minimum distance or maximum correlation with the centroid of any (e.g., each) cluster may be selected. Let cⱼ∈ [symbol] ^{N}^{ᵣ} denote the identified centroid from K-means, for i=0, . . . , P₁−1. The WTRU (e.g., UE) may choose the port p_{j,1}, as

$${p}_{j , 1} = {min}_{i} \vert \vert {c}_{j} - {h}_{j i} {\vert \vert}^{2}$$

and hⱼᵢ is the column of the full matrix H_{f} that is associated with port i, where port i belongs to cluster j.

According to embodiments, the WTRU (e.g., UE) may select/recommend the size of the subset P₁ based on the number of PUCCH/PUSCH payload bits (B), or physical downlink shared channel (PDSCH) performance (e.g., BLER).

If the WTRU (e.g., UE) is configured to select from preconfigured subsets, (e.g., then) the WTRU (e.g., UE) may first determine the clusters and the associated ports followed by choosing the subset that has the maximum number of ports from the different clusters.

### Representative Adaptively Update of the Determined Subset

The determined subset may be subject to change based on how time-varying the channel is. The WTRU (e.g., UE) may be configured to determine when the previously determined subset may (e.g., needs to) be updated based on channel related measurements. In this case, the DNN model may be designed to deal with variable input and variable output dimensions (e.g., using convolutional neural network (CNN) with drop out). According to embodiments, the WTRU (e.g., UE) may be configured with different sets of DNN models; any (e.g., each) can have a different P₁ value.
The WTRU (e.g., UE) may track the changes in the reduced channel H_{A}∈ [symbol] ^{N}^{ᵣ}^{×P}^{₁} over time. For example, the WTRU (e.g., UE) may store the initial estimated channel H_{A}, denoted as H_{A}[0]. At any (e.g., each) subsequent time slot, t, the WTRU (e.g., UE) may perform measurement based on a function ƒ(H_{A}[0], H_{A}[t]). For example, the function can be the NMSE, e.g.,

$$f ( {H}_{A} [ 0 ] , {H}_{A} [ t ] ) = \frac{\vert \vert {H}_{A} [ 0 ] - {H}_{A} [ t ] ) {\vert \vert}_{F}^{2}}{\vert \vert {H}_{A} [ 0 ] {\vert \vert}_{F}^{2}}$$

where ∥.∥^{F} denotes the Frobenius-norm. The WTRU (e.g., UE) may compare the resulting NMSE at any (e.g., each) time with a certain preconfigured threshold. The WTRU (e.g., UE) may trigger a report for full port transmission if the measured NMSE is greater than some preconfigured NMSE threshold.
According to embodiments, the WTRU (e.g., UE) may request full port CSI-RS transmission H_{f}∈ [symbol] ^{N}^{ᵣ}^{×P} based on PDSCH performance. For example, if BLER drops below a predefined BLER threshold.
According to embodiments, the WTRU (e.g., UE) may store the centroids associated vectors {cⱼ∈ [symbol] ^{N}^{ᵣ}}, for j=0, . . . , P₁−1. For example, let C=[c₀, c₁, . . . , c_{P-1}]∈ [symbol] ^{N}^{ᵣ}^{×P}^{₁} be a matrix that holds the centroids in its columns. The WTRU (e.g., UE) may perform measurements based on a function, ƒ(C, H_{A}). For example, the WTRU (e.g., UE) may determine if the previously determined antenna ports are still associated with their clusters or some of them became closer to another clusters. According to embodiments, the WTRU (e.g., UE) may determine the new port assignment using the correlation function,

ƒ(C,H_{A})=C^{H}H_{A}
where any (e.g., each) column of C and H_{A} may (e.g., is assumed to) be of unit norm. The WTRU (e.g., UE) may trigger a report for full port transmission, for example, if the number of ports that will be assigned to a new cluster is greater than some preconfigured value.
The WTRU (e.g., UE) may request full port transmission based on channel measurements. For example, the WTRU (e.g., UE) may trigger a report for full port transmission if the estimated Doppler exceeds a certain preconfigured threshold. In another example, the WTRU (e.g., UE) may trigger a report if the change in estimated angle of arrival exceeds a certain preconfigured threshold.
The WTRU (e.g., UE) may store the CSI associated with the first subset and (e.g., only) request CSI-RS transmission on the second subset to update the first subset, as opposed to full port transmission. For example, if the WTRU (e.g., UE) detected that the determined subset may (e.g., needs to) be updated, the WTRU (e.g., UE) may request CSI-RS transmission to estimate H_{B} at time t and (e.g., then) update the first subset based on H_{B}[t] and H_{A}[t−1].

### Numerical Results

To show the validity of the proposed framework, a numerical example for using K-means is now presented. The adopted simulation parameters may be as follows. The clustered delay line (CDL)-A channel model is used with the delay spread set to 300 ns, carrier frequency set to 4 GHz, and number of transmit antenna ports set to 128. Both the base station and the WTRU (e.g., UE) are equipped with uniform linear arrays where the antenna elements are separated by a half wavelength. A wideband setting may be used (e.g., is assumed) wherein the channel matrix may be obtained by averaging out the channels across 20 resource blocks.

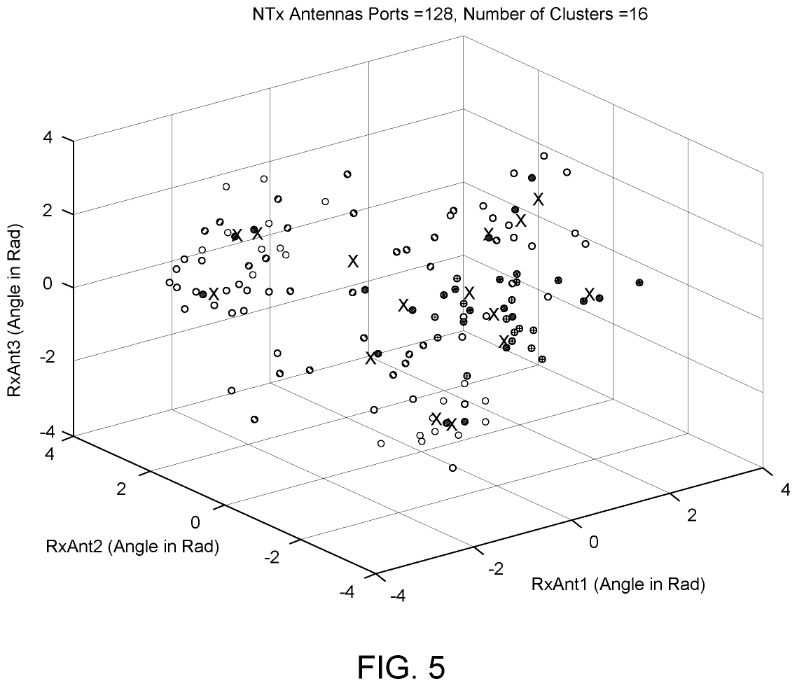

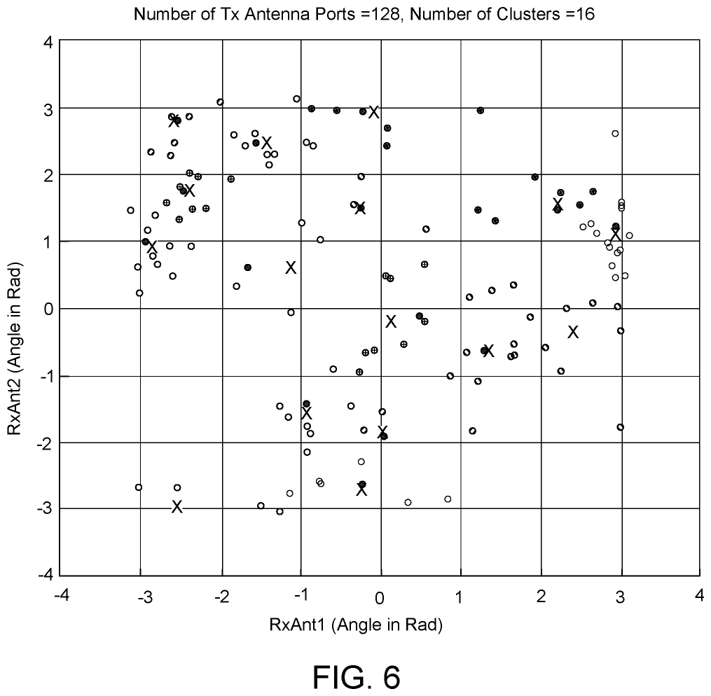

The size of the first subset (number of centroids) may be set to 16. The following two scenarios are considered: scenario I with Nᵣ=2, which corresponds to clustering in the 2D space; and scenario II with Nᵣ=3, which corresponds to clustering in the 3D space. The results shown in FIG. 5 and FIG. 6 are scenario I and scenario II, respectively. The cluster centroids are depicted by the black ‘x’s while the closest antenna port to any (e.g., each) of the 16 clusters is depicted by a red circle. Those ports may be considered as the representative ports that may (e.g., needs to) be signaled back to the BS (e.g., gNB). The minimum correlation coefficients associated with scenario I and scenario II are measured as 0.66 and 0.72, respectively. Recall that the correlation may be improved by increasing P₁ (number of centroids) and may be reduced by decreasing P₁.

### Representative Indication of the Subset of Antenna Ports

A WTRU (e.g., UE) may be configured to indicate the selected antenna ports (indices).

### Explicit Indication of the Identified Subset

According to embodiments, a WTRU (e.g., UE) may be configured, indicated, or requested to report information of a subset of antenna ports (e.g., identified antenna port subset) based on the measurement and/or evaluation of a measurement reference signal (e.g., CSI-RS, TRS, etc.). Hereafter, the term antenna port may be interchangeably used with antenna, virtual antenna, logical antenna, antenna port number, antenna port index, and physical antenna. One or more of following may apply:
The subset of antenna ports may be referred to as a CSI reporting quantity (e.g., antenna port indices).
A subset of antenna port indices may be reported by a WTRU (e.g., UE) as preferred or required antenna ports for measurement RS.
A maximum number of antenna port indices in the reporting may be determined based on any of the following:
   The capacity of the uplink feedback resource configured, used, or determined.
   Configured by a higher layer (e.g., Radio Resource Control (RRC), Media Access Control-Control Element (MAC-CE)) number of antenna ports for the measurement RS which may be a target for the RS overhead reduction.
WTRU (e.g., UE) capability of RS overhead reduction (e.g., AIML capability) reporting of the identified antenna port subset may be triggered by the BS (e.g., gNB) via L1 signaling (e.g., DCI) or configured to report periodically or semi-persistently via higher layer signaling. The subset of antenna ports may include the full set of antenna ports. (E.g., in this case) A WTRU (e.g., UE) may skip reporting subset of antenna ports, and the absence of the signal may be considered a report to use the full set of antenna ports.

According to embodiments, a WTRU (e.g., UE) may determine to report information of the identified antenna port subset in a case where (e.g., when) any of the following conditions may be met:
identified antenna port subset is changed from the previous reporting.
measurement quality based on the current antenna port subset is below a threshold. (E.g., in this case) The WTRU (e.g., UE) may indicate to a BS (e.g., gNB) that the measurement quality (e.g., channel measurement quality) is below a threshold. This indication may be considered or interpreted as an indication that the full set of antenna ports may (e.g., is needed) or preferred for the channel measurement.
channel estimation/prediction quality from the current antenna port subset is below a threshold.
AIML model for channel estimation or measurement accuracy is below a threshold.

The WTRU (e.g., UE) may indicate the identified antenna subset through uplink signaling to be used for CSI-RS transmission. The CSI report may include the identified subset and/or the associated CSI. The signaling can be done (e.g., explicitly) through modified UCI, using PUCCH and/or PUSCH, or implicitly using a specific PUCCH, random access channel (RACH), or sounding reference signal (SRS) resources.
According to embodiments, the WTRU (e.g., UE) may be configured with UCI resources with different formats. The different formats may have different number of bits, number of resources blocks, etc., to indicate the identified antenna subset information. For example, the format may indicate including the identified antenna subset indices and the corresponding CSI or part thereof.
According to embodiments, a format may indicate including the identified subset with the associated PMI based on the reduced size CSI.
The WTRU (e.g., UE) may send back the selected antenna ports over the PUCCH or PUSCH.
The feedback may include the CSI report associated with the (reduced) antenna set.
If the WTRU (e.g., UE) reaches a maximum number of centroids (P1), but does not meet the required correlation threshold, it may report this explicitly or implicitly as part of the reporting mechanism. A fallback to legacy configuration may be used.
Impact on uplink reporting if the determined P1 is less than maxP1.
According to embodiments, selected antenna subset may be associated with certain preconfigured indices to facilitate efficient feedback between the base station and the terminal.
According to embodiments, the WTRU (e.g., UE) may indicate an increase or decrease in the number of antennas in the subset through a simple up/down command.

The following section describes a reporting of channel measurements of a subset of antenna ports.

According to embodiments, a BS (e.g., gNB) may indicate to or request a WTRU (e.g., UE) to report channel measurement of a subset of antenna ports. From the channel measurement of the subset of antenna ports, the BS (e.g., gNB) may estimate channel information of other antenna ports, for example, by using an AIML model trained at the BS (e.g., gNB) and/or WTRU (e.g., UE).

One or more types of CSI reportings (or channel measurement reporting) may be used, wherein a first type of CSI reporting may include channel information of all antenna ports and/or a second type of CSI reporting may include channel information of a subset of antenna ports.

The first type of CSI reporting may be configured with a first time period (e.g., periodic, or semi-persistent; long-term) and/or the second type of CSI reporting may be configured with a second time period (e.g., aperiodic, short-term).

A WTRU (e.g., UE) may be indicated or informed about which subset of antenna ports may (e.g., need to) be reported, for example, when it is triggered or requested to report.

When a WTRU (e.g., UE) reports CSI, the type of CSI reporting may be determined based on any of the following:
Uplink resource type determined. For example, when PUSCH is used for CSI reporting, a first type of CSI reporting may be used; otherwise, a second type of CSI reporting may be used.
Uplink resource amount determined. For example, when the CSI reporting resource can carry a number of information bits larger than a threshold, a first type of CSI reporting may be used; otherwise, a second type of CSI reporting may be used.
Dropping of a part of CSI may be used (e.g., is needed) or not. For example, if the uplink resource has enough capacity to report CSI of full antenna ports, a first type of CSI reporting may be used; otherwise, a second type of CSI reporting may be used, wherein the number of antenna ports for the CSI reporting may be determined based on the uplink resource capacity.

Hereafter, the term CSI may be interchangeably used with channel measurement, channel measurement of full antenna ports, channel measurement of subset of antenna ports, channel matrix, CSI reporting, CSI reporting setting, CSI measurement resource, and CSI reporting quantity (e.g., PMI, RI, CQI, LI).

### CSI Feedback Reporting Based on Subset of Antenna Ports

A WTRU (e.g., UE) may be configured to derive CSI (or a quantity thereof) based on reference signal measurements from a first set of antenna port(s). For example, the first set of antenna ports may be a subset of the total number of antenna ports configured for the WTRU (e.g., UE). A second set of antenna ports may be defined and/or determined, for example, such that the union of the first set of antenna ports and the second set of antenna ports may be equal to the total number of configured antenna ports for the WTRU (e.g., UE). A WTRU (e.g., UE) may be configured to predict CSI (or a quantity thereof) for a second set of antenna port(s). The WTRU (e.g., UE) may use the CSI derived from the first set of antenna port to predict CSI for the second set of antenna port(s). According to embodiments, the first set of antenna ports may be referred to as the ‘measured subset’ and/or the second set of antenna ports may be referred to as the ‘predicted subset’. According to embodiments, the WTRU (e.g., UE) may be (e.g., explicitly) configured with the measured subset and predicted subset. According to embodiments, the WTRU (e.g., UE) may determine which antenna port(s) may be comprised in (e.g., constitute) the measured subset and which antenna port(s) may be comprised in (e.g., constitute) the predicted subset. The WTRU (e.g., UE) may be configured with criteria to determine the subsets. For example, the WTRU (e.g., UE) may partition the subset(s) to achieve any of the following: partitioning such that the CSI prediction error over the second set of antenna ports is minimized. For example, the NMSE between the predicted CSI and/or the actual CSI may be below a threshold and/or partition such that the reference signal transmission overhead is minimized and/or the CSI feedback transmission overhead is minimized.

A WTRU (e.g., UE) may derive a CSI quantity (e.g., PMI) based on at least one antenna port from a first set (e.g., a measured subset), and/or that the WTRU (e.g., UE) may transmit the CSI report associated with antenna ports part of (e.g., constituting) the first set of antenna ports.

According to embodiments, the WTRU (e.g., UE) may be configured to receive CSI-RS associated with the subset of antenna ports out of a total number of configured antenna ports. For example, such subset of antenna ports may correspond to first set of antenna ports (e.g., ‘measured subset’). The WTRU (e.g., UE) may be configured to determine CSI quantity (e.g., PMI or any other implicit CSI) associated with a first set of antenna port(s). The WTRU (e.g., UE) may be configured to report the CSI determined over the first set of antenna ports. According to embodiments, the WTRU (e.g., UE) may be configured to include an (e.g., explicit) indication of the first set of antenna ports, for example, along with the CSI report. According to embodiments, the WTRU (e.g., UE) may be preconfigured with a PUCCH resource set, and any (e.g., each) PUCCH resource may be associated with a different subset of antenna ports. The WTRU (e.g., UE) may determine the PUCCH resources for CSI transmission based on determination of the first set of antenna ports. For example, such an embodiment may be beneficial to reduce the RS transmission overhead and/or CSI feedback overhead. The BS (e.g., gNB) may determine the CSI associated with the second set of antenna ports based on a CSI report received for the first set of antenna ports, for example, using a predictor AIML model.

A WTRU (e.g., UE) may derive and/or transmit CSI report containing channel measurement (e.g., channel matrix or derived quantity thereof) based on first set of antenna ports (e.g., a measured subset) and/or an indication of antenna ports part of (e.g., constituting) the first set of antenna ports.

Any of the embodiments above may be also extended to the case of (e.g., explicit) CSI reporting wherein the WTRU (e.g., UE) may be configured to derive and report (e.g., explicit) CSI for a subset of antenna ports among a configured total number of antenna ports. According to embodiments, the WTRU (e.g., UE) may be configured to perform any of the following steps: determine a first set of antenna ports using one or more of the methods described herein, derive (e.g., explicit) CSI associated with the first set of antenna ports, compress the (e.g., explicit) CSI, and transmit the compressed CSI associated with the first set of antenna ports. For example, such an embodiment may be beneficial to reduce the RS transmission overhead and/or CSI feedback overhead. The BS (e.g., gNB) may employ a AIML model to translate received CSI over a subset of antenna port to a CSI over a full set of antenna ports.

A WTRU (e.g., UE) may derive a first CSI quantity (e.g., PMI) based on at least one antenna port from a first set (e.g., a measured subset) and second CSI quantity (e.g., PMI) based on one or more antenna ports from a second set (e.g., a predicted subset)—the WTRU (e.g., UE) may transmit the CSI report with the first and second CSI quantity along with indication of antenna ports part of (e.g., constituting) the first and/or second set of antenna ports

According to embodiments, the WTRU (e.g., UE) may be configured to receive CSI-RS associated with a subset of antenna ports out of the total number of configured antenna ports. For example, such subset of antenna ports may correspond to the first set of antenna ports (e.g., ‘measured subset’). The WTRU (e.g., UE) may be configured to determine two types of CSI. The first CSI quantity (e.g., PMI or any other implicit CSI thereof) may be associated with the first set of antenna ports. For example, the WTRU (e.g., UE) may be configured to derive CSI based on CSI-RS received on the first set of antenna ports. The second CSI quantity (e.g., PMI or any other implicit CSI thereof) may be associated with the second set of antenna ports. For example, the WTRU (e.g., UE) may be configured to predict the CSI on the second set of antenna ports based on the CSI derived from the first set of antenna ports. For example, such prediction may be performed with an AIML model. For example, the AIML model at the WTRU (e.g., UE) may be configured by the network. For example, the AIML model at the WTRU (e.g., UE) may be predefined. For example, the AIML model at the WTRU (e.g., UE) may be based on WTRU (e.g., UE) implementation. The WTRU (e.g., UE) may be configured to report both the first CSI quantity and the second CSI quantity in the CSI report.

According to embodiments, the WTRU (e.g., UE) may indicate that the CSI report contains at least one quantity that is derived based on measurement of CSI-RS and/or another CSI quantity based on CSI prediction in the spatial domain. For example, the WTRU (e.g., UE) may indicate the association between the CSI and the subset of antenna ports for which the CSI is applicable. According to embodiments, the WTRU (e.g., UE) may be configured to indicate implicitly or explicitly the antenna ports that may be comprised in (e.g., constitutes) the first and second set of antenna ports.

A WTRU (e.g., UE) may transmit CSI report containing channel measurement (e.g., channel matrix or a processed quantity thereof) based on at least one antenna port from a first set (e.g., a measured subset) and one or more antenna ports from a second set (e.g., a predicted subset), and the WTRU (e.g., UE) may transmit the CSI report along with indication of the antenna ports comprising the first set and/or second set of antenna ports.

Any of the embodiments above may be also extended to the case of (e.g., explicit) CSI reporting wherein the WTRU (e.g., UE) may be configured to derive and/or report (e.g., explicit) CSI for a first subset of antenna ports and/or for a second set of antenna ports. According to embodiments, the WTRU (e.g., UE) may be configured to perform any of the following steps: determine a first set of antenna ports and second set of antenna ports using one or more of the methods described herein, derive (e.g., explicit) CSI associated with the first set and/or second of antenna ports, compress the (e.g., explicit) CSI, and/or transmit the compressed CSI associated with the first and second set of antenna ports. For example, such an embodiment may be beneficial in reducing the RS transmission overhead and/or CSI feedback overhead.

### Frequency Domain Representatives to Reduce the RS Overhead

Background: CSI-RS may be configured to cover the bandwidth of the assigned bandwidth part (BWP) partially or entirely. Within the configured bandwidth, CSI-RS may be configured for transmission in every Resource Block (RB) (density=1) or every other RB (density=½) with extra configuration regarding the set or resource blocks (e.g., even, or odd). CSI-RS overhead may be reduced by dynamically controlling the CSI-RS frequency density given a target channel estimation performance.

One possible approach is to start from a density (ρ)=1 and adaptively change this based on WTRU (e.g., UE) measurements. For example, given the initial estimated channel H[k]∈ [symbol] ^{N}^{ᵣ}^{×P}, (at ρ=1), for k=1, . . . , K, and K is the number of RBs, the WTRU (e.g., UE) can construct one compact channel matrix G=[h₁, . . . , h_{K}]∈ [symbol] ^{N}^{ᵣ}^{P×K}, where hₖ is the vectorized H[k]. The [symbol] WTRU (e.g., UE) can determine a first set of RBs K₁ out of the total number of RBs, K, that can be used to predict the channel associated with the other set of size K₂. For instance, matrices H_{A}∈ [symbol] ^{N}^{ᵣ}^{P×|K}^{₁}^{|} and H_{B}∈ [symbol] ^{N}^{ᵣ}^{P×|K}^{₂}^{|} can be formed, where K₁ and K₂ are two disjoint subsets, with |K₁|+|K₂|=K, |K₁|≤|K₂| and K₁∩K₂=0. For example, a DNN can be trained to map an input H_{A}∈ [symbol] ^{N}^{ᵣ}^{P×|K}^{₁}^{|} to an output H_{B}∈ [symbol] ^{N}^{ᵣ}^{P×|K}^{₂}^{|}.

### Representative RB Subset Selection

A WTRU (e.g., UE) may be configured with different patterns of CSI-RS resources in the frequency domain. For example, there may be N different configured frequency densities with one configuration containing CSI-RS resources in every RB, another configuration containing CSI-RS resources in every other RB, yet another in every third RB, and so on up to a configuration containing CSI-RS resources in every N RB.

For any (e.g., each) configured frequency density, the WTRU (e.g., UE) may be configured with different configurations of the CSI-RS resources. For example, one configuration may include CSI-RS in every Nth RB starting at the first RB, another configuration may include CSI-RS resources in every Nth RB starting on the second RB, and so on up to a configuration that may include CSI-RS resources in every Nth RB starting on the Nth RB.

Initially, and periodically, the BS (e.g., gNB) may transmit CSI-RSs on a default pattern of frequency resources. For example, the BS (e.g., gNB) may transmit CSI-RSs on every RB within the BWP. The WTRU (e.g., UE) may estimate the channel coefficients using this maximal set of resources for CSI-RS transmissions. The WTRU (e.g., UE) may (e.g., then) determine the correlations across different RBs within the BWP. For example, the WTRU (e.g., UE) may determine the mean squared error between the channel estimates for different RB combinations, and, from that, conclude that by designating N groups of RBs, it is possible to ensure that the maximum difference in channel coefficients within any (e.g., each) group/cluster is smaller than a pre-configured value.

If the WTRU (e.g., UE) determines that the correlation between a pair of RBs is larger than a pre-configured value, (e.g., then) it may report to the BS (e.g., gNB) to eliminate CSI-RS transmissions on one of the RBs. According to embodiments, the WTRU (e.g., UE) may make this determination based on another metric, for example, the mean squared error between the channel coefficients corresponding to the pair of RBs.

The WTRU (e.g., UE) may extend this determination to more than a pair of RBs, e.g., N RBs, and (e.g., then) identify such groups of N RBs that have channel coefficients that are similar to each other based on some measure.

The WTRU (e.g., UE) may (e.g., then) be able to determine the channel coefficients for all RBs within the BWP, based on channel measurements on a sub-set of the frequency resources for CSI-RS transmission, due to the observed correlation across RBs.

The WTRU (e.g., UE) may signal to the BS (e.g., gNB) the RB indices on which it may use (e.g., needs) to measure the channel coefficients to determine the channel coefficients for the entire BWP. According to embodiments, the WTRU (e.g., UE) may provide the indices of all the RBs in the set. According to embodiments, multiple such RB combinations may have been pre-configured by the BS (e.g., gNB). The WTRU (e.g., UE) may choose one of the RB combinations and signal its index to the BS (e.g., gNB).

The WTRU (e.g., UE) may request CSI-RS transmissions on the default frequency pattern to the BS (e.g., gNB). The WTRU (e.g., UE) may do so, for example, when it determines that the channel coefficient estimation from a subset of the RBs is not sufficient to provide an estimate of the channel coefficients for the full BWP, at a pre-required accuracy level. The WTRU (e.g., UE) may make this determination, for example, based on observing the BLER of downlink shared channel transmissions.

According to embodiments, the WTRU (e.g., UE) may be configured with a temporal pattern of CSI-RS transmissions, such that the BS (e.g., gNB) cycles over different frequency patterns. For example, the BS (e.g., gNB) may transmit CSI-RS on the default frequency pattern, e.g., either on every RB or on every other RB, at the start of the cycle of L consecutive transmissions, and (e.g., then) transmit on a reduced sub-set of RBs identified previously by the WTRU (e.g., UE) for (L−1) occasions. According to embodiments, the WTRU (e.g., UE) may be configured with a temporal pattern of CSI-RS transmissions starting with a default frequency pattern at the first instance, followed by a pattern of CSI-RS frequency density, N₁, N₂, N₃ on the succeeding instances of transmission within the cycle, before rolling back to the default frequency pattern at the start of the next cycle.

### Representative RB Subset

The WTRU (e.g., UE) may be configured to determine and indicate a set of representative RBs in the allocated BWP to be used for CSI-RS transmission. The WTRU (e.g., UE) may determine the set of RBs in a way that can reduce the CSI-RS overhead while maintaining a target performance (e.g., channel estimation or PDSCH performance).

### Mechanism to Determine the RB Subset

The WTRU (e.g., UE) may determine the minimum number of RBs together with their indices/locations based on a preconfigured correlation/NMSE threshold or a channel estimation performance related metric configured by the BS (e.g., gNB). The determined RBs may be used to predict the channel coefficients associated with the other (non-selected) RBs in the allocated BWP. The WTRU (e.g., UE) may use a DNN approach or linear interpolation to predict the channel associated with the other RBs. According to embodiments the WTRU (e.g., UE) may determine which method to use based on the computed correlation of the identified RBs.

The WTRU (e.g., UE) may determine the set of representative RBs by applying a clustering approach to the initial full estimated channel H[k]∈ [symbol] ^{N}^{ᵣ}^{×N}^{ₜ} across all RBs, i.e., k=1, . . . , K, where K is the number of RBs in the allocated BWP. According to embodiments, the WTRU (e.g., UE) may use K-means to cluster/group any (e.g., each) set of correlated RBs together. The WTRU (e.g., UE) may tune the number of clusters (K₁) until a global correlation threshold test is met. In K-means, for instance, K₁ is equivalent to the number of centroids. The WTRU (e.g., UE) can change the number of centroids until finding the K₁ that satisfies a predefined criterion (e.g., correlation coefficient or/and reporting overhead constraint). According to embodiments, the WTRU (e.g., UE) can set K₁ based on a preconfigured density. For example, the WTRU (e.g., UE) may be configured with one of eight possible density levels between 0 and 1, and the WTRU (e.g., UE) may determine the K₁ RB indices from the configured BWP based on the configured density.

The WTRU (e.g., UE) may recommend the density that achieves a predefined correlation threshold. For example, the WTRU (e.g., UE) may report one of the possible preconfigured densities such that a target channel estimation performance is met.

The WTRU (e.g., UE) may determine the representative RB index per cluster by measuring the distance between the cluster centroid and the closest RB to the centroid, or by looking at the cosine similarity between the CSI associated with the closest RB and the centroid. For example, let [h₁, . . . , h₄] denote the NᵣNₜ-dimensional channel vectors associated with one of the resulting clusters with the centroid c∈ [symbol] ^{N}^{ᵣ}^{N}^{ₜ}. The WTRU (e.g., UE) may determine the representative RB index in that cluster by selecting the one with minimum distance or maximum correlation with the cluster centroid. For example, the WTRU (e.g., UE) can determine the RB index as

$${i}^{*} = {max}_{i} \frac{{h}_{i}^{H} c}{‖ {h}_{i} ‖ ‖ c ‖}$$

for all i∈{1,2,3,4}.

The WTRU (e.g., UE) may (e.g., only) report the indices of the representative RB for any (e.g., each) identified cluster. The WTRU (e.g., UE) may indicate whether the RBs associated with the same cluster are contiguous or not. Such information may, for example, help the BS (e.g., gNB) to adjust the density within any (e.g., each) RB or choose the subcarrier locations, or may be useful for scheduling aspects.

### Numerical Results

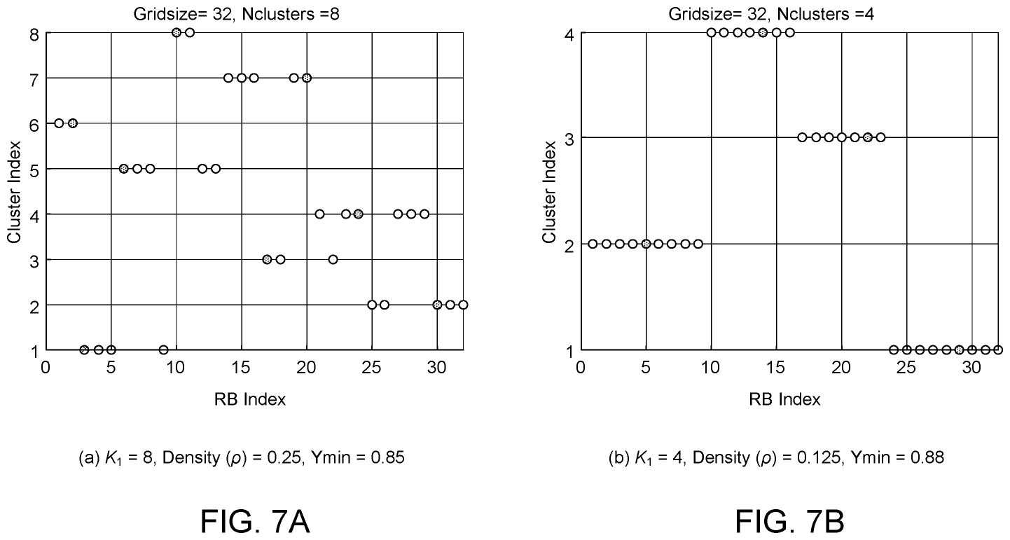

To show how-well K-means works in the frequency domain, two simulation scenarios with different density values were implemented. FIGS. 7A and 7B show the results for the two scenarios. The adopted simulation parameters are as follows. The CDL-A channel model is adopted, carrier frequency is set to 4 GHz, number of transmit antenna antennas is set to 32, and number of receive antennas is set to 3. Both BS and WTRU (e.g., UE) may be equipped with uniform linear array where the antenna elements are separated by a half wavelength. The bandwidth part size may be set to 32 resource blocks.

The following two scenarios are considered: scenario I with delay spread set to 300 ns and the number of clusters set to 8 RBs which corresponds to density 0.25, and in scenario II, the delay spread is set to 30 ns and number of clusters is set to 4 RBs, which corresponds to a density of 0.125. The results shown in FIG. 7A and FIG. 7B are for scenario I and scenario II, respectively. The two figures show the RB indices associated with any (e.g., each) cluster. Further, the representative RB for any (e.g., each) cluster is depicted in red circle. The representative RBs are determined based on the computed correlation between any (e.g., each) RB and the centroid of the same cluster. These are the RB indices that may (e.g., need to) be signaled back to the BS (e.g., gNB). In FIG. 7B, for example, the representative RB indices are (5, 14, 22, 29). The minimum correlation coefficient associated with scenario I and scenario II are measured as 0.85 and 0.88, respectively. Recall that the correlation can be controlled by tuning K₁ (number of centroids). One can also see that the RBs per cluster in FIG. 7B seem to be contiguous but with variable size per cluster, while the RBs in scenario I in FIG. 7A are non-contiguous due to the large delay spread.

### Representative Report of the Identified Subset of RB

The following section describes a subset of RB determination by the WTRU (e.g., UE).

According to embodiments, a WTRU (e.g., UE) may be configured, requested, or indicated to report a subset of RBs that the WTRU (e.g., UE) may (e.g., need to) measure the channel to acquire channel information of the configured bandwidth. For example, a BWP may be configured, used, or determined for a WTRU (e.g., UE) to measure CSI and report the measured CSI. With this reported information, a BS (e.g., gNB) may transmit measurement reference signals in the subset of RBs indicated or reported by the WTRU (e.g., UE). Any of the following may apply:
The indication (or reporting) associated with a subset of RBs may include the indices of the RBs or the associated CSI reporting. It may be determined based on which node (e.g., BS (e.g., gNB) and/or WTRU (e.g., UE)) has AIML capability.
The indication (or reporting) of a subset of RBs may be based on one or more subband index reported. For example, a WTRU (e.g., UE) may report or indicate indices of subbands which may require measurement of reference signals. For example, one or more subbands may be configured, defined, or used in a BWP, and a WTRU (e.g., UE) may report a bitmap that indicates which subband requires measurement of reference signals to acquire channel information of the BWP.
   The subband size (or minimum subband size) may be determined based on the uplink resource determined (e.g., capacity, uplink resource type) and or predetermined conditions (e.g., dropping occurs or not, quality of measurement, accuracy of the AIML model). A smaller subband size may require larger number of bits to indicate the subset of RBs.
The indication (or reporting) of a subset of RBs may be based on one or more clusters, wherein a cluster may be defined or indicated as a starting RB within a BWP and a number of consecutive RBs. The one or more clusters may be mutually exclusive (e.g., non-overlapping in frequency domain).
   The number of clusters (or maximum number of clusters) may be determined based on the uplink resource determined (e.g., capacity, uplink resource type) and or predetermined conditions (e.g., dropping occurs or not, quality of measurement, accuracy of the AIML model). A larger number of clusters may require more bits to indicate the subset of RBs.
The indication (or reporting) of a subset of RBs may be a spacing of neighboring RBs. For example, a first subset of RBs may be RBs located every 2 RBs (e.g., even-numbered RB or odd-numbered RB), a second subset of RBs may be RBs located every 3 RBs.

Hereafter, the term measurement reference signal may be used interchangeably with demodulation reference signal (e.g., DMRS), tracking reference signal (TRS), phase tracking reference signal (PTRS), and SRS.

The following section describes a subset of RB determination at the BS (e.g., gNB).

According to embodiments, a BS (e.g., gNB) may indicate or determine a subset of RBs for a WTRU (e.g., UE) to measure and/or report the CSI. From the channel measurement of the subset of RBs, the BS (e.g., gNB) may estimate channel information of other RBs by using an AIML model trained at the BS (e.g., gNB) and/or WTRU (e.g., UE).

One or more types of CSI reporting (or channel measurement reporting) may be used, wherein a first type of CSI reporting may include channel information of all RBs in a BWP and a second type of CSI reporting may include channel information of a subset of RBs in the BWP.
The first type of CSI reporting may be configured with a first time period (e.g., periodic, or semi-persistent; long-term) and the second type of CSI reporting may be configured with a second time period (e.g., aperiodic, short-term).
A WTRU (e.g., UE) may be indicated or informed about which subset of RBs may (e.g., needs to) be reported when it is triggered or requested to report.

In a case where (e.g., when) a WTRU (e.g., UE) reports CSI, the type of CSI reporting may be determined based on any of the following:
Uplink resource type determined. For example, when PUSCH is used for CSI reporting, a first type of CSI reporting may be used; otherwise, a second type of CSI reporting may be used.
Uplink resource amount determined. For example, when CSI reporting resource can carry a number of information bits larger than a threshold, a first type of CSI reporting may be used; otherwise, a second type of CSI reporting may be used.
Dropping of a part of CSI may be used (e.g., needed) or not. For example, if the uplink resource has enough capacity to report CSI of the full RBs in a BWP, a first type of CSI reporting may be used; otherwise, a second type of CSI reporting may be used, wherein the number of RBs for the CSI reporting may be determined based on the uplink resource capacity.

### Csi Feedback Reporting Based on Dynamic RB Subset Selection

A WTRU (e.g., UE) may be configured to derive CSI (or a quantity thereof) based on CSI-RS transmitted on a subset of resource blocks (RBs) within the configured bandwidth part. The CSI reporting may be the PMI associated with the representative RBs together with information related to the different identified clusters/groups of RBs. According to embodiments, the CSI reporting may include the (compressed) reduced channel matrix of (e.g., only) the representative RBs, and (e.g., then) linear (e.g., interpolation) or non-linear (e.g., DNN) methods can be used to predict the full channel matrix associated with all RBs.

A WTRU (e.g., UE) may derive a CSI quantity (e.g., PMI) based on the estimated channel associated with the selected RBs.

According to embodiments, the WTRU (e.g., UE) may be configured to receive CSI-RS on a subset of RBs (e.g., recommended by the WTRU (e.g., UE)). The WTRU (e.g., UE) may be configured to determine and report the PMI associated with the selected subset of RBs. This may be equivalently thought of as down-sampling the frequency domain, but wherein the sampling locations (selected RBs) are determined and recommended by the WTRU (e.g., UE) (as opposed to uniform down-sampling or averaging the channel for any (e.g., each) cluster/group of RBs). The WTRU (e.g., UE) may be configured to include an (e.g., explicit) indication of the indices of RBs associated with any (e.g., each) cluster/group to assist in the precoding procedure. According to embodiments, if the determined RBs associated with any (e.g., each) cluster/group are indicated as contiguous, the WTRU (e.g., UE) may be configured to derive and report the PMI of the representative RBs together with the size of any (e.g., each) cluster and the starting RB index for any (e.g., each) cluster.

A WTRU (e.g., UE) may be configured to directly report the estimated channel associated with the selected RBs.

According to embodiments, the WTRU (e.g., UE) may be configured to send back the reduced channel matrix, (which may be a compressed version) associated with the preconfigured subset of RBs. This may be beneficial for high correlation scenarios, e.g., low density and high correlation per cluster. The BS (e.g., gNB) may use a CSI prediction method (e.g., supervised as DNN or unsupervised as interpolation/extrapolation).

The following section describes a fallback to legacy clustering.

A WTRU (e.g., UE) may be configured to recommend using either dynamic clustering or legacy clustering. Here, legacy-based clustering refers to cluster/group contiguous RBs with fixed subband size, e.g., same number of RBs per cluster. Dynamic clustering may include clusters with contiguous or non-contiguous RBs and variable numbers of RBs per cluster. The WTRU (e.g., UE) may determine/recommend whether to use dynamic or legacy clustering. For example, the WTRU (e.g., UE) may compare the resulting downlink overhead and the uplink feedback overhead associated with both approaches, and recommend the one with lower overhead.

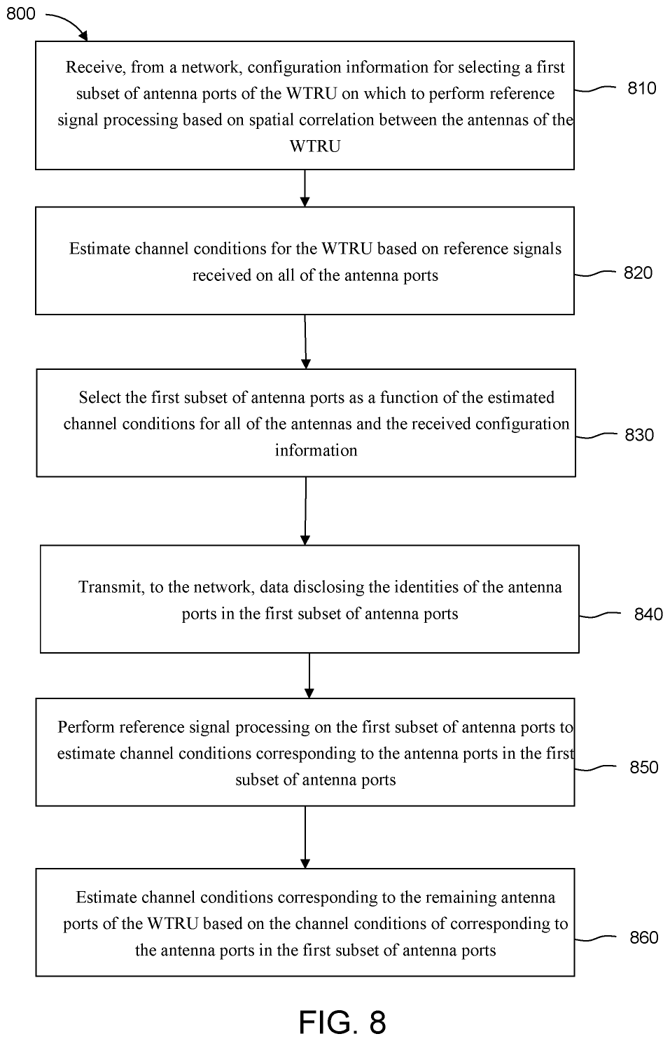

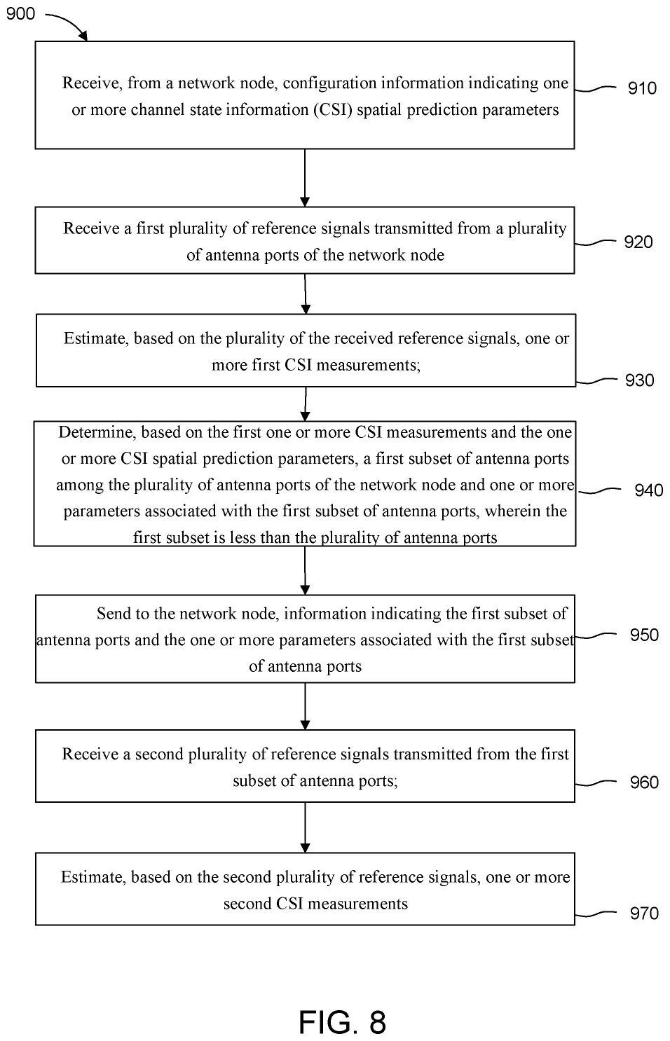

FIG. 8 illustrates an example of a method 800 implemented in a WTRU 102 comprising a plurality of antennas and corresponding antenna ports.

According to embodiments, the WTRU 102 may be configured to receive, from a network, configuration information for selecting a first subset of antenna ports of the WTRU on which to perform reference signal processing, for example, based on spatial correlation between the antennas of the WTRU (810).

According to embodiments, the WTRU 102 may be configured to estimate channel conditions for the WTRU based on reference signals received, for example, on all of the antenna ports (820).

According to embodiments, the WTRU 102 may be configured to select the first subset of antenna ports as a function of the estimated channel conditions, for example, for all of the antennas and the received configuration information (830).

According to embodiments, the WTRU 102 may be configured to transmit, to the network, data disclosing the identities of the antenna ports in the first subset of antenna ports (840).

According to embodiments, the WTRU 102 may be configured to perform reference signal processing on the first subset of antenna ports to estimate channel conditions corresponding to the antenna ports in the first subset of antenna ports (850).

According to embodiments, the WTRU 102 may be configured to estimate channel conditions corresponding to the remaining antenna ports of the WTRU based on the channel conditions of corresponding to the antenna ports in the first subset of antenna ports (860).

According to embodiments, the selection of the first subset of antennas may be based on meeting a threshold of a maximum difference between channel conditions of antenna ports in the first subset of antenna ports.

According to embodiments, the received configuration information may include one or more of: (1) a maximum number of antenna ports that may be included in the first subset of antenna ports; (2) a method for determining the first subset of antenna ports; and (3) a metric for spatial correlation between the first subset of antenna ports and a second subset of antenna ports, the second subset of antenna ports comprising antenna ports not in the first subset of antenna ports.

According to embodiments, the selection of the first subset of antennas may be performed using an artificial intelligence/machine learning process.

According to embodiments, the artificial intelligence/machine learning process may utilize a DNN model.

According to embodiments, the WTRU may be configured to: determine a condition indicative of changes in channel conditions meeting a criterion; and responsive to such determination, alter the first subset of antenna ports.

According to embodiments, the condition indicative of changes in channel conditions meeting a criterion may comprise a data transfer error rate exceeding a threshold.

FIG. 9 illustrates an example of a method 900 implemented in a WTRU 102 comprising a plurality of antennas and corresponding antenna ports.

According to embodiments, the WTRU 102 may be configured to receive, from a network node, configuration information indicating one or more channel state information (CSI) spatial prediction parameters (910).

According to embodiments, the WTRU 102 may be configured to receive a first plurality of reference signals transmitted from a plurality of antenna ports of the network node (920).

According to embodiments, the WTRU 102 may be configured to perform/estimate, based on the plurality of the received reference signals, one or more first CSI measurements (930).

According to embodiments, the WTRU 102 may be configured to determine, based on the one or more first CSI measurements and the one or more CSI spatial prediction parameters, a first subset of antenna ports among the plurality of antenna ports of the network node and/or one or more parameters associated with the first subset of antenna ports (940). For example, the first subset may be less than the plurality of antenna ports.

According to embodiments, the WTRU 102 may be configured to send to the network node, information indicating the first subset of antenna ports and/or the one or more parameters associated with the first subset of antenna ports (950).

According to embodiments, the WTRU 102 may be configured to receive a second plurality of reference signals transmitted from the first subset of antenna ports (960).

According to embodiments, the WTRU 102 may be configured to perform/estimate, based on the second plurality of reference signals, one or more second CSI measurements (970).

According to embodiments, the WTRU 102 may be configured to predict, for example, based on the estimated one or more second CSI measurements, one or more third CSI measurements for a second subset of antenna ports of the plurality of antenna ports of the network node.

According to embodiments, the WTRU 102 may be configured to send CSI feedback information comprising CSI measurements for any of: (1) the first subset of antenna ports, (2) second subset of antenna ports, and (3) the plurality of antenna ports.

According to embodiments, the WTRU 102 may be configured to send CSI feedback information indicating any of: (1) the first CSI measurements, (2) the second CSI measurements, and (3) the third CSI measurements.

According to embodiments, the one or more CSI spatial prediction parameters may comprise any of: (1) a maximum number of antenna ports of the first subset of antenna ports, for example for the determination of the first subset of antenna ports; (2) a method for determining the first subset of antenna ports; and (3) a metric for spatial correlation between the first subset of antenna ports and the second subset of antenna ports.

According to embodiments, the second subset of antenna ports may be the complement of the first subset of antenna ports.

According to embodiments, the WTRU 102 may be configured to predict the one or more third CSI measurements for the second subset of antenna ports using an artificial intelligence/machine learning model.

According to embodiments, the one or more parameters associated with the first subset of antenna ports may comprise one or more channel coefficients associated with the first subset of antenna ports.

According to embodiments, the WTRU 102 configured to determine a first subset of antenna ports may comprise the WTRU 102 configured to determine the first subset of antenna ports based on meeting a threshold of a minimum correlation between the one or more channel coefficients associated with the first subset of antenna ports.

According to embodiments, the one or more channel coefficients associated with the first subset of antenna ports may be one or more first channel coefficients associated with the first subset of antenna ports, and the WTRU 102 may be configured to predict based on the one or more first channel coefficients associated with the first subset of antenna ports, one or more second channel coefficients associated with the second subset of antenna ports.

According to embodiments, the WTRU 102 may be configured to send to the network node, information indicating the one or more second channel coefficients associated to the second subset of antenna ports.

According to embodiments, the WTRU 102 may be configured to determine a condition indicative of one or more changes in one or more channel conditions associated to the first subset of antenna ports, wherein the condition may be based on estimating one or more fifth CSI measurements based on a third plurality of reference signals transmitted from the first subset of antenna ports; and responsive to such determination, the WTRU 102 may be configured to alter the first subset of antenna ports.

According to embodiments, the condition may comprise a data block/transfer error rate exceeding a threshold.

### CONCLUSION

Systems and methods for processing data according to representative embodiments may be performed by one or more processors executing sequences of instructions contained in a memory device. Such instructions may be read into the memory device from other computer-readable mediums such as secondary data storage device(s). Execution of the sequences of instructions contained in the memory device causes the processor to operate, for example, as described above. In alternative embodiments, hard-wire circuitry may be used in place of or in combination with software instructions to implement the present invention. Such software may run on a processor which is housed within a robotic assistance/apparatus (RAA) and/or another mobile device remotely. In the later a case, data may be transferred via wireline or wirelessly between the RAA or other mobile device containing the sensors and the remote device containing the processor which runs the software which performs the scale estimation and compensation as described above. According to other representative embodiments, some of the processing described above with respect to localization may be performed in the device containing the sensors/cameras, while the remainder of the processing may be performed in a second device after receipt of the partially processed data from the device containing the sensors/cameras.

Although features and elements are provided above in particular combinations, one of ordinary skill in the art will appreciate that each feature or element can be used alone or in any combination with the other features and elements. The present disclosure is not to be limited in terms of the particular embodiments described in this application, which are intended as illustrations of various aspects. Many modifications and variations may be made without departing from its spirit and scope, as will be apparent to those skilled in the art. No element, act, or instruction used in the description of the present application should be construed as critical or essential to the invention unless explicitly provided as such. Functionally equivalent methods and apparatuses within the scope of the disclosure, in addition to those enumerated herein, will be apparent to those skilled in the art from the foregoing descriptions. Such modifications and variations are intended to fall within the scope of the appended claims. The present disclosure is to be limited only by the terms of the appended claims, along with the full scope of equivalents to which such claims are entitled. It is to be understood that this disclosure is not limited to particular methods or systems.

The foregoing embodiments are discussed, for simplicity, with regard to the terminology and structure of infrared capable devices, i.e., infrared emitters and receivers. However, the embodiments discussed are not limited to these systems but may be applied to other systems that use other forms of electromagnetic waves or non-electromagnetic waves such as acoustic waves.

It is also to be understood that the terminology used herein is for the purpose of describing particular embodiments only, and is not intended to be limiting. As used herein, the term “video” or the term “imagery” may mean any of a snapshot, single image and/or multiple images displayed over a time basis. As another example, when referred to herein, the terms “user equipment” and its abbreviation “UE”, the term “remote” and/or the terms “head mounted display” or its abbreviation “HMD” may mean or include (i) a wireless transmit and/or receive unit (WTRU); (ii) any of a number of embodiments of a WTRU; (iii) a wireless-capable and/or wired-capable (e.g., tetherable) device configured with, inter alia, some or all structures and functionality of a WTRU; (iii) a wireless-capable and/or wired-capable device configured with less than all structures and functionality of a WTRU; or (iv) the like. Details of an example WTRU, which may be representative of any WTRU recited herein, are provided herein with respect to FIGS. 1A-1D. As another example, various disclosed embodiments herein supra and infra are described as utilizing a head mounted display. Those skilled in the art will recognize that a device other than the head mounted display may be utilized and some or all of the disclosure and various disclosed embodiments can be modified accordingly without undue experimentation. Examples of such other device may include a drone or other device configured to stream information for providing the adapted reality experience.

In addition, the methods provided herein may be implemented in a computer program, software, or firmware incorporated in a computer-readable medium for execution by a computer or processor. Examples of computer-readable media include electronic signals (transmitted over wired or wireless connections) and computer-readable storage media. Examples of computer-readable storage media include, but are not limited to, a read only memory (ROM), a random access memory (RAM), a register, cache memory, semiconductor memory devices, magnetic media such as internal hard disks and removable disks, magneto-optical media, and optical media such as CD-ROM disks, and digital versatile disks (DVDs). A processor in association with software may be used to implement a radio frequency transceiver for use in a WTRU, UE, terminal, base station, RNC, MME, EPC, AMF, or any host computer.

Variations of the method, apparatus and system provided above are possible without departing from the scope of the invention. In view of the wide variety of embodiments that can be applied, it should be understood that the illustrated embodiments are examples only, and should not be taken as limiting the scope of the following claims. For instance, the embodiments provided herein include handheld devices, which may include or be utilized with any appropriate voltage source, such as a battery and the like, providing any appropriate voltage.

Moreover, in the embodiments provided above, processing platforms, computing systems, controllers, and other devices that include processors are noted. These devices may include at least one Central Processing Unit (“CPU”) and memory. In accordance with the practices of persons skilled in the art of computer programming, reference to acts and symbolic representations of operations or instructions may be performed by the various CPUs and memories. Such acts and operations or instructions may be referred to as being “executed,” “computer executed” or “CPU executed.”

One of ordinary skill in the art will appreciate that the acts and symbolically represented operations or instructions include the manipulation of electrical signals by the CPU. An electrical system represents data bits that can cause a resulting transformation or reduction of the electrical signals and the maintenance of data bits at memory locations in a memory system to thereby reconfigure or otherwise alter the CPU's operation, as well as other processing of signals. The memory locations where data bits are maintained are physical locations that have particular electrical, magnetic, optical, or organic properties corresponding to or representative of the data bits. It should be understood that the embodiments are not limited to the above-mentioned platforms or CPUs and that other platforms and CPUs may support the provided methods.

The data bits may also be maintained on a computer readable medium including magnetic disks, optical disks, and any other volatile (e.g., Random Access Memory (RAM)) or non-volatile (e.g., Read-Only Memory (ROM)) mass storage system readable by the CPU. The computer readable medium may include cooperating or interconnected computer readable medium, which exist exclusively on the processing system or are distributed among multiple interconnected processing systems that may be local or remote to the processing system. It should be understood that the embodiments are not limited to the above-mentioned memories and that other platforms and memories may support the provided methods.

In an illustrative embodiment, any of the operations, processes, etc. described herein may be implemented as computer-readable instructions stored on a computer-readable medium. The computer-readable instructions may be executed by a processor of a mobile unit, a network element, and/or any other computing device.

There is little distinction left between hardware and software implementations of aspects of systems. The use of hardware or software is generally (but not always, in that in certain contexts the choice between hardware and software may become significant) a design choice representing cost versus efficiency tradeoffs. There may be various vehicles by which processes and/or systems and/or other technologies described herein may be effected (e.g., hardware, software, and/or firmware), and the preferred vehicle may vary with the context in which the processes and/or systems and/or other technologies are deployed. For example, if an implementer determines that speed and accuracy are paramount, the implementer may opt for a mainly hardware and/or firmware vehicle. If flexibility is paramount, the implementer may opt for a mainly software implementation. Alternatively, the implementer may opt for some combination of hardware, software, and/or firmware.

The foregoing detailed description has set forth various embodiments of the devices and/or processes via the use of block diagrams, flowcharts, and/or examples. Insofar as such block diagrams, flowcharts, and/or examples include one or more functions and/or operations, it will be understood by those within the art that each function and/or operation within such block diagrams, flowcharts, or examples may be implemented, individually and/or collectively, by a wide range of hardware, software, firmware, or virtually any combination thereof. In an embodiment, several portions of the subject matter described herein may be implemented via Application Specific Integrated Circuits (ASICs), Field Programmable Gate Arrays (FPGAs), digital signal processors (DSPs), and/or other integrated formats. However, those skilled in the art will recognize that some aspects of the embodiments disclosed herein, in whole or in part, may be equivalently implemented in integrated circuits, as one or more computer programs running on one or more computers (e.g., as one or more programs running on one or more computer systems), as one or more programs running on one or more processors (e.g., as one or more programs running on one or more microprocessors), as firmware, or as virtually any combination thereof, and that designing the circuitry and/or writing the code for the software and or firmware would be well within the skill of one of skill in the art in light of this disclosure. In addition, those skilled in the art will appreciate that the mechanisms of the subject matter described herein may be distributed as a program product in a variety of forms, and that an illustrative embodiment of the subject matter described herein applies regardless of the particular type of signal bearing medium used to actually carry out the distribution. Examples of a signal bearing medium include, but are not limited to, the following: a recordable type medium such as a floppy disk, a hard disk drive, a CD, a DVD, a digital tape, a computer memory, etc., and a transmission type medium such as a digital and/or an analog communication medium (e.g., a fiber optic cable, a waveguide, a wired communications link, a wireless communication link, etc.).

Those skilled in the art will recognize that it is common within the art to describe devices and/or processes in the fashion set forth herein, and thereafter use engineering practices to integrate such described devices and/or processes into data processing systems. That is, at least a portion of the devices and/or processes described herein may be integrated into a data processing system via a reasonable amount of experimentation. Those having skill in the art will recognize that a typical data processing system may generally include one or more of a system unit housing, a video display device, a memory such as volatile and non-volatile memory, processors such as microprocessors and digital signal processors, computational entities such as operating systems, drivers, graphical user interfaces, and applications programs, one or more interaction devices, such as a touch pad or screen, and/or control systems including feedback loops and control motors (e.g., feedback for sensing position and/or velocity, control motors for moving and/or adjusting components and/or quantities). A typical data processing system may be implemented utilizing any suitable commercially available components, such as those typically found in data computing/communication and/or network computing/communication systems.

The herein described subject matter sometimes illustrates different components included within, or connected with, different other components. It is to be understood that such depicted architectures are merely examples, and that in fact many other architectures may be implemented which achieve the same functionality. In a conceptual sense, any arrangement of components to achieve the same functionality is effectively “associated” such that the desired functionality may be achieved. Hence, any two components herein combined to achieve a particular functionality may be seen as “associated with” each other such that the desired functionality is achieved, irrespective of architectures or intermedial components. Likewise, any two components so associated may also be viewed as being “operably connected”, or “operably coupled”, to each other to achieve the desired functionality, and any two components capable of being so associated may also be viewed as being “operably couplable” to each other to achieve the desired functionality. Specific examples of operably couplable include but are not limited to physically mateable and/or physically interacting components and/or wirelessly interactable and/or wirelessly interacting components and/or logically interacting and/or logically interactable components.

With respect to the use of substantially any plural and/or singular terms herein, those having skill in the art can translate from the plural to the singular and/or from the singular to the plural as is appropriate to the context and/or application. The various singular/plural permutations may be expressly set forth herein for sake of clarity.

It will be understood by those within the art that, in general, terms used herein, and especially in the appended claims (e.g., bodies of the appended claims) are generally intended as “open” terms (e.g., the term “including” should be interpreted as “including but not limited to,” the term “having” should be interpreted as “having at least,” the term “includes” should be interpreted as “includes but is not limited to,” etc.). It will be further understood by those within the art that if a specific number of an introduced claim recitation is intended, such an intent will be explicitly recited in the claim, and in the absence of such recitation no such intent is present. For example, where only one item is intended, the term “single” or similar language may be used. As an aid to understanding, the following appended claims and/or the descriptions herein may include usage of the introductory phrases “at least one” and “one or more” to introduce claim recitations. However, the use of such phrases should not be construed to imply that the introduction of a claim recitation by the indefinite articles “a” or “an” limits any particular claim including such introduced claim recitation to embodiments including only one such recitation, even when the same claim includes the introductory phrases “one or more” or “at least one” and indefinite articles such as “a” or “an” (e.g., “a” and/or “an” should be interpreted to mean “at least one” or “one or more”). The same holds true for the use of definite articles used to introduce claim recitations. In addition, even if a specific number of an introduced claim recitation is explicitly recited, those skilled in the art will recognize that such recitation should be interpreted to mean at least the recited number (e.g., the bare recitation of “two recitations,” without other modifiers, means at least two recitations, or two or more recitations). Furthermore, in those instances where a convention analogous to “at least one of A, B, and C, etc.” is used, in general such a construction is intended in the sense one having skill in the art would understand the convention (e.g., “a system having at least one of A, B, and C” would include but not be limited to systems that have A alone, B alone, C alone, A and B together, A and C together, B and C together, and/or A, B, and C together, etc.). In those instances where a convention analogous to “at least one of A, B, or C, etc.” is used, in general such a construction is intended in the sense one having skill in the art would understand the convention (e.g., “a system having at least one of A, B, or C” would include but not be limited to systems that have A alone, B alone, C alone, A and B together, A and C together, B and C together, and/or A, B, and C together, etc.). It will be further understood by those within the art that virtually any disjunctive word and/or phrase presenting two or more alternative terms, whether in the description, claims, or drawings, should be understood to contemplate the possibilities of including one of the terms, either of the terms, or both terms. For example, the phrase “A or B” will be understood to include the possibilities of “A” or “B” or “A and B.” Further, the terms “any of” followed by a listing of a plurality of items and/or a plurality of categories of items, as used herein, are intended to include “any of,” “any combination of,” “any multiple of,” and/or “any combination of multiples of” the items and/or the categories of items, individually or in conjunction with other items and/or other categories of items. Moreover, as used herein, the term “set” is intended to include any number of items, including zero. Additionally, as used herein, the term “number” is intended to include any number, including zero. And the term “multiple”, as used herein, is intended to be synonymous with “a plurality”.

In addition, where features or aspects of the disclosure are described in terms of Markush groups, those skilled in the art will recognize that the disclosure is also thereby described in terms of any individual member or subgroup of members of the Markush group.

As will be understood by one skilled in the art, for any and all purposes, such as in terms of providing a written description, all ranges disclosed herein also encompass any and all possible subranges and combinations of subranges thereof. Any listed range can be easily recognized as sufficiently describing and enabling the same range being broken down into at least equal halves, thirds, quarters, fifths, tenths, etc. As a non-limiting example, each range discussed herein may be readily broken down into a lower third, middle third and upper third, etc. As will also be understood by one skilled in the art all language such as “up to,” “at least,” “greater than,” “less than,” and the like includes the number recited and refers to ranges which can be subsequently broken down into subranges as discussed above. Finally, as will be understood by one skilled in the art, a range includes each individual member. Thus, for example, a group having 1-3 cells refers to groups having 1, 2, or 3 cells. Similarly, a group having 1-5 cells refers to groups having 1, 2, 3, 4, or 5 cells, and so forth.

Moreover, the claims should not be read as limited to the provided order or elements unless stated to that effect. In addition, use of the terms “means for” in any claim is intended to invoke 35 U.S.C. § 112, ¶6 or means-plus-function claim format, and any claim without the terms “means for” is not so intended.

Suitable processors include, by way of example, a general purpose processor, a special purpose processor, a conventional processor, a digital signal processor (DSP), a plurality of microprocessors, one or more microprocessors in association with a DSP core, a controller, a microcontroller, Application Specific Integrated Circuits (ASICs), Application Specific Standard Products (ASSPs); Field Programmable Gate Arrays (FPGAs) circuits, any other type of integrated circuit (IC), and/or a state machine.

The WTRU may be used in conjunction with modules, implemented in hardware and/or software including a Software Defined Radio (SDR), and other components such as a camera, a video camera module, a videophone, a speakerphone, a vibration device, a speaker, a microphone, a television transceiver, a hands free headset, a keyboard, a Bluetooth® module, a frequency modulated (FM) radio unit, a Near Field Communication (NFC) Module, a liquid crystal display (LCD) display unit, an organic light-emitting diode (OLED) display unit, a digital music player, a media player, a video game player module, an Internet browser, and/or any Wireless Local Area Network (WLAN) or Ultra Wide Band (UWB) module.

Although the various embodiments have been described in terms of communication systems, it is contemplated that the systems may be implemented in software on microprocessors/general purpose computers (not shown). In certain embodiments, one or more of the functions of the various components may be implemented in software that controls a general-purpose computer.

In addition, although the invention is illustrated and described herein with reference to specific embodiments, the invention is not intended to be limited to the details shown. Rather, various modifications may be made in the details within the scope and range of equivalents of the claims and without departing from the invention.

1. A method implemented in a Wireless Transmit Receive Unit (WTRU), the method comprising:
receiving, from a network node, configuration information indicating one or more channel state information (CSI) spatial prediction parameters;
receiving a first plurality of reference signals transmitted from a plurality of antenna ports of the network node;
estimating, based on the first plurality of reference signals, one or more first CSI measurements;
determining, based on the one or more first CSI measurements and the one or more CSI spatial prediction parameters, a first subset of antenna ports among the plurality of antenna ports of the network node and one or more parameters associated with the first subset of antenna ports, wherein the first subset is less than the plurality of antenna ports;
sending, to the network node, information indicating the first subset of antenna ports and the one or more parameters associated with the first subset of antenna ports;
receiving a second plurality of reference signals transmitted from the first subset of antenna ports; and
estimating, based on the second plurality of reference signals, one or more second CSI measurements.

2. The method according to claim 1, comprising:
predicting, based on the one or more second CSI measurements, one or more third CSI measurements for a second subset of antenna ports of the plurality of antenna ports of the network node; and
sending CSI feedback information indicating any of: (1) the one or more first CSI measurements, (2) the one or more second CSI measurements, and (3) the one or more third CSI measurements.

3. The method according to claim 2, wherein the one or more CSI spatial prediction parameters comprise any of: (1) a maximum number of antenna ports of the first subset of antenna ports; (2) a method for determining the first subset of antenna ports; and (3) a metric for spatial correlation between the first subset of antenna ports and the second subset of antenna ports.

4. The method according to claim 2, wherein the second subset of antenna ports is the complement of the first subset of antenna ports.

5. The method according to claim 2, comprising predicting the one or more third CSI measurements for the second subset of antenna ports using an artificial intelligence/machine learning model.

6. The method according to claim 2, wherein the one or more parameters associated with the first subset of antenna ports comprise one or more channel coefficients associated with the first subset of antenna ports.

7. The method according to claim 6, wherein determining a first subset of antenna ports comprises determining the first subset of antenna ports based on meeting a threshold of a minimum correlation between the one or more channel coefficients associated with the first subset of antenna ports.

8. The method according to claim 6, wherein the one or more channel coefficients associated with the first subset of antenna ports are one or more first channel coefficients associated with the first subset of antenna ports, the method comprising:
predicting based on the one or more first channel coefficients associated with the first subset of antenna ports, one or more second channel coefficients associated with the second subset of antenna ports; and
sending, to the network node, information indicating the one or more second channel coefficients associated to the second subset of antenna ports.

9. The method according to claim 2, comprising:
determining a condition indicative of one or more changes in one or more channel conditions associated to the first subset of antenna ports, wherein the condition is based on estimating one or more fifth CSI measurements based on a third plurality of reference signals transmitted from the first subset of antenna ports; and
responsive to such determination, altering the first subset of antenna ports.

10. The method according to claim 9, wherein the condition comprises a data block error rate exceeding a threshold.

11. A wireless transmit/receive unit (WTRU) comprising circuitry, including a transmitter, a receiver, a processor and memory, the WTRU configured to:
receive, from a network node, configuration information indicating one or more channel state information (CSI) spatial prediction parameters;
receive a first plurality of reference signals transmitted from a plurality of antenna ports of the network node;
estimate, based on the first plurality of reference signals, one or more first CSI measurements;
determine, based on the one or more first CSI measurements and the one or more CSI spatial prediction parameters, a first subset of antenna ports among the plurality of antenna ports of the network node and one or more parameters associated with the first subset of antenna ports, wherein the first subset is less than the plurality of antenna ports;
send to the network node, information indicating the first subset of antenna ports and the one or more parameters associated with the first subset of antenna ports;
receive a second plurality of reference signals transmitted from the first subset of antenna ports; and
estimate, based on the second plurality of reference signals, one or more second CSI measurements.

12. The WTRU according to claim 11, configured to:
predict, based on the one or more second CSI measurements, one or more third CSI measurements for a second subset of antenna ports of the plurality of antenna ports of the network node; and
send CSI feedback information indicating any of: (1) the one or more first CSI measurements, (2) the one or more second CSI measurements, and (3) the one or more third CSI measurements.

13. The WTRU according to claim 12, wherein the one or more CSI spatial prediction parameters comprise any of (1) a maximum number of antenna ports of the first subset of antenna ports; (2) a method for determining the first subset of antenna ports; and (3) a metric for spatial correlation between the first subset of antenna ports and the second subset of antenna ports.

14. The WTRU according to claim 12, wherein the second subset of antenna ports is the complement of the first subset of antenna ports.

15. The WTRU according to claim 12, configured to predict the one or more third CSI measurements for the second subset of antenna ports using an artificial intelligence/machine learning model.

16. The WTRU according to claim 12, wherein the one or more parameters associated with the first subset of antenna ports comprise one or more channel coefficients associated with the first subset of antenna ports.

17. The WTRU according to claim 16, wherein the WTRU configured to determine a first subset of antenna ports comprises the WTRU configured to determine the first subset of antenna ports based on meeting a threshold of a minimum correlation between the one or more channel coefficients associated with the first subset of antenna ports.

18. The WTRU according to claim 16, wherein the one or more channel coefficients associated with the first subset of antenna ports are one or more first channel coefficients associated with the first subset of antenna ports, wherein the WTRU is configured to:
predict based on the one or more first channel coefficients associated with the first subset of antenna ports, one or more second channel coefficients associated with the second subset of antenna ports; and
send to the network node, information indicating the one or more second channel coefficients associated to the second subset of antenna ports.

19. The WTRU according to claim 12, configured to:
determine a condition indicative of one or more changes in one or more channel conditions associated to the first subset of antenna ports, wherein the condition is based on estimating one or more fifth CSI measurements based on a third plurality of reference signals transmitted from the first subset of antenna ports; and
responsive to such determination, alter the first subset of antenna ports.

20. The WTRU according to claim 19, wherein the condition comprises a data block error rate exceeding a threshold.
